(19) United States
(12) Patent Application Publication
(10) Pub. No.: US 2026/0289181 A1
(43) Pub. Date: Sep. 24, 2026

(54) SYSTEM

(71) Applicant: SoftBank Group Corp., Tokyo (JP)

(72) Inventor: Kana NAKAGAWA, okyo (JP)

(73) Assignee: SoftBank Group Corp., Tokyo (JP)

(21) Appl. No.: 19/567,360

(22) Filed: Mar. 16, 2026

(30) Foreign Application Priority Data
Mar. 19, 2025 (JP) 2025-045069

(51) Int. Cl. G06F 40/40; G06F 40/30; G10L 13/027

(52) U.S. Cl. CPC G06F 40/40; G06F 40/30; G10L 13/027

(57) ABSTRACT

A system includes a processor that is configured to receive, from a user, a first prompt that instructs reproduction of wording and tone of a character, and analyze the first prompt by using a generative AI model, generate information by using the generative AI model based on a second prompt that instructs random provision of information and calls in a communication network, and generate a response by using the generative AI model based on a third prompt that instructs analysis of a text input from the user, recognition of an emotion by using emotion recognition technology, and generation of a role-playing response based on the recognized emotion.

### CROSS-REFERENCE TO RELATED APPLICATION

This application is based on and claims priority under 35 USC 119 from Japanese Patent Application No. 2025-045069 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional communication support systems and chatbots mainly provide static or rule-based responses and therefore cannot flexibly reproduce diverse wording and tone corresponding to various characters or roles. As a result, user engagement and emotional resonance in digital communication environments such as team chats and social platforms remain limited. In particular, existing systems are not suitably configured to: (i) allow a user to explicitly instruct reproduction of the wording and tone of an arbitrary character, (ii) cause a system to autonomously and randomly provide information and calls to action in a communication network to activate communication, and (iii) analyze a user's text input, recognize the user's emotional state, and generate an emotionally adaptive role-playing response matching a designated character. Furthermore, conventional systems often lack integrated use of generative AI models and emotion recognition technology in a unified framework that dynamically controls prompts to the generative AI model. Accordingly, there is a need for a system that, by appropriate prompt control to a generative AI model, can reproduce character-specific language, autonomously generate random information and calls in a communication network, and generate role-playing responses based on recognized emotions, thereby enriching communication experiences and improving user satisfaction.

### SUMMARY

In order to solve the above-described problems, according to one aspect of the present invention, there is provided a system comprising a processor, wherein the processor is configured to receive, from a user, a first prompt that instructs reproduction of wording and tone of a character, and analyze the first prompt by using a generative AI model, to generate information by using the generative AI model based on a second prompt that instructs random provision of information and calls in a communication network, and to generate a response by using the generative AI model based on a third prompt that instructs analysis of a text input from the user, recognition of an emotion by using emotion recognition technology, and generation of a role-playing response based on the recognized emotion. In one embodiment, the processor is further configured to imitate a specific dialect by using the generative AI model based on a fourth prompt that instructs imitation of the specific dialect. In another embodiment, the processor is further configured to imitate a fictional character by using the generative AI model based on a fifth prompt that instructs imitation of the fictional character. By combining prompt-based control for reproducing wording and tone, for randomly generating information and calls within a network, and for generating emotionally adaptive role-playing responses, the system enables flexible and expressive character-based communication, thereby enhancing interactivity and engagement in communication environments.

The term “processor” refers to any hardware component or combination of hardware components, such as a CPU, GPU, ASIC, FPGA, or a plurality thereof, that executes instructions to perform the functions described in the present specification and claims.

The term “generative AI model” refers to a machine-learned model, such as a neural network model, configured to generate text, audio, images, or other content in response to an input, including but not limited to large language models and other generative models.

The term “prompt” refers to data, typically text, supplied to the generative AI model as an instruction or context that specifies or guides the content, style, or behavior of the output generated by the generative AI model.

The term “character” refers to a person, persona, role, or entity, whether real, fictional, or archetypal, whose wording, tone, style, or behavior is to be reproduced or imitated by the system.

The term “wording and tone” refers to linguistic characteristics including choice of words, phrasing, level of formality, register, manner of speaking, and emotional nuance associated with a character.

The term “communication network” refers to any wired, wireless, or hybrid network that allows data communication between devices, including but not limited to the Internet, local area networks, wide area networks, and cloud-based communication platforms.

The term “information” refers to content generated by the generative AI model, including but not limited to messages, questions, notifications, calls to action, or other textual or multimedia outputs provided to a user via the communication network.

The term “call” refers to a message or content that prompts, invites, or encourages one or more users to respond, participate, or take an action within a communication environment.

The term “user” refers to any person or entity that interacts with the system, including by providing prompts, text inputs, or other data, and by receiving outputs generated by the system.

The term “text input” refers to character-based data entered or transmitted by the user, such as chat messages, commands, or other textual content provided to the system.

The term “emotion recognition technology” refers to any algorithm, model, or processing technique configured to infer or classify an emotional state from user data, including but not limited to analysis of text, voice, facial expressions, physiological signals, or combinations thereof.

The term “emotion” refers to a mental or affective state attributed to the user, such as happiness, sadness, anger, surprise, fear, or other emotional categories or dimensions recognized by the emotion recognition technology.

The term “role-playing response” refers to a response generated by the generative AI model that is expressed in a manner consistent with a designated character, role, wording, tone, or dialect, and that is adapted based on recognized emotion or context.

The term “specific dialect” refers to a regional, social, or cultural variant of a language characterized by distinctive vocabulary, pronunciation, grammar, or expressions, which the system imitates in generated outputs.

The term “fictional character” refers to a character that does not exist in reality, including but not limited to characters from novels, comics, games, films, or original characters defined for the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

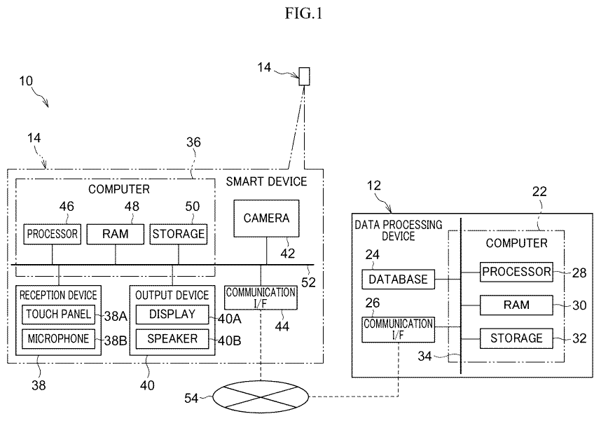

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

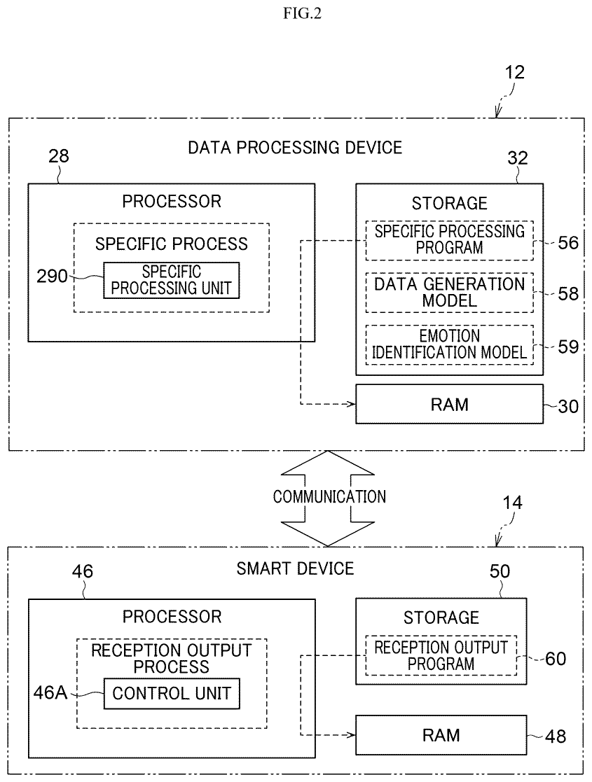

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In networked collaboration environments, conventional computer-implemented communication systems, such as group chat tools and messaging platforms, typically rely on static, rule-based templates or manually authored messages to facilitate exchanges among users. These systems do not adapt message style, timing, or content based on a persistent persona configuration, user-defined role information, or accumulated interaction history. As a result, the generated communications are often monotonous, lack contextual variation, and fail to react intelligently to group-specific preferences or past behavior, which limits the effectiveness of the system in promoting sustained user engagement.

From a computing technology standpoint, existing dialogue systems generally treat a generative AI model as a simple text completion engine invoked per request with ad-hoc prompts. Such systems do not manage, at the server side, a structured and persistent layer of “role configuration” and “group context,” including base prompt sentences, topic preferences, and user response histories, that are automatically combined when invoking the generative AI model. Consequently, the processor does not effectively control the generative AI model to maintain a consistent persona across sessions, does not systematically adjust prompt sentences based on accumulated interaction data, and does not optimize the scheduling and targeting of generated messages. This leads to inefficient use of computational resources and inconsistent output quality, because each invocation of the generative AI model is performed without leveraging previously stored context and without programmatic control over how prompts evolve over time.

Moreover, many existing systems rely on client-side scripts or manual user actions to trigger communications, so server-side logic does not autonomously select message topics, does not compute randomized or context-dependent timing, and does not generate group-tailored prompts. This architecture increases processing redundancy across clients and fails to centralize control over how generative AI output is produced and distributed. The lack of an integrated server-side mechanism to: (i) register an information processing function as a member of a communication group, (ii) schedule random or context-aware information provision, and (iii) transform structured report data into role-based natural language, results in a communication infrastructure that is technically inflexible and poorly suited to dynamic, persona-driven interaction.

Therefore, there is a need for an improved computer-implemented system in which a processor centrally manages role information, base prompt sentences, user or group-level configuration, and interaction history, and uses that information to programmatically construct and supply prompt sentences to a generative AI model. Such a system should maintain consistent role expression across multiple exchanges, automatically adjust generated content to characteristics of a communication group, and optimize timing and content selection based on stored data, thereby improving the functioning of the underlying communication and dialogue infrastructure itself, rather than merely presenting different content to human users.

The specific processing by the specific processing unit 290 of the data processing device 12 in Example 1 is realized by the following means.

The present invention provides a server comprising a processor and a memory storing instructions that, when executed by the processor, cause the processor to: read, from a storage region, a generative AI model, initialize the generative AI model, and input to the generative AI model a prompt sentence including role information and language expression conditions designated by a user, thereby setting a dialogue style according to a role; acquire group identification information for identifying a communication group on a communication network, register an information processing function as a member of the communication group, determine a time for performing information provision or a call for attention on the basis of time information and random number generation processing, and input to the generative AI model a prompt sentence based on a determination result and the role information to generate information to be transmitted to the communication group; acquire character information of a user from a terminal device, store the character information in a storage device, and input to the generative AI model a prompt sentence based on the character information and the role information to generate response information in which the role is played, and transmit the response information to the terminal device via the communication network; acquire a prompt sentence including, for each user or for each communication group, at least one of role information, writing style conditions, utterance length constraints, and topic types, store the prompt sentence as a base setting for the generative AI model, and automatically add the base setting in subsequent information generation to call the generative AI model, thereby realizing dialogue in which role expression is continuously maintained; acquire report information including at least one of task content information and behavior record information, combine the report information with the role information as a prompt sentence, input the prompt sentence to the generative AI model to generate transformed report information in which factual content is maintained and an expression according to the role is applied, and distribute the transformed report information to the communication group; and accumulate response history information of users in the communication group, extract, on the basis of the response history information, at least one of topic candidates and preference tendencies, and input to the generative AI model a prompt sentence including an extraction result to generate information for performing information provision or a call for attention according to characteristics of the communication group. This enables the server-side computing infrastructure to control and adapt the behavior of the generative AI model in a stateful and context-aware manner, to maintain consistent persona expression across multiple interactions, to generate group-tailored and time-adaptive messages without client-side orchestration, and to improve the efficiency and technical performance of the communication system by reusing stored role configurations and interaction histories when constructing prompt sentences.

The term “processor” refers to a hardware execution unit, such as a central processing unit or an equivalent arithmetic and logic device, that executes instructions to perform data processing operations as described in the present specification.

The term “memory” refers to a hardware storage resource, including at least one of a volatile storage device and a non-volatile storage device, that stores instructions and data for access by the processor.

The term “storage region” refers to a logical or physical portion of a memory or storage device in which programs, models, configuration data, and interaction data related to the system are stored.

The term “generative AI model” refers to a machine-implemented information processing model configured to generate data, including natural language text, based on input data such as prompt sentences and internal learned parameters.

The term “generation-type information processing model” refers to a category of computational models, including the generative AI model, that are designed to produce output data by statistically or algorithmically transforming input data.

The term “prompt sentence” refers to an instruction text, query text, or structured input expression that is supplied to the generative AI model to specify desired output characteristics, including at least one of role information, writing style, topic, or constraints.

The term “role information” refers to data indicating a persona, character, or behavioral profile, including at least one of occupation type, personality type, narrative role, or fictional role, that conditions how the generative AI model should phrase or structure its output.

The term “language expression conditions” refers to constraints or preferences for generated text, including at least one of formality level, politeness level, vocabulary range, sentence length, tone, and linguistic register.

The term “dialogue style” refers to a combination of role information and language expression conditions that determines how messages generated by the generative AI model are phrased, including aspects such as tone, sentence structure, and interaction pattern.

The term “communication network” refers to a wired or wireless data transmission infrastructure, including at least one of a local area network, a wide area network, and a packet-switched network, over which data is exchanged between the server and terminal devices.

The term “communication group” refers to a logical collection of multiple user accounts or devices, such as a group chat, channel, or virtual room, that is configured to share and exchange messages over the communication network.

The term “group identification information” refers to data used to uniquely identify a communication group within a communication platform, including at least one of a group ID, channel ID, or room identifier.

The term “information processing function” refers to a server-side software module or bot-like process that participates in a communication group as a member and performs automated message generation, reception, or processing.

The term “time information” refers to temporal data, including at least one of current time, calendar date, and elapsed time, used to determine when information should be generated or transmitted.

The term “random number generation processing” refers to a computational procedure that produces pseudo-random or random values, used to determine non-deterministic timing or selection of topics for message generation.

The term “information provision” refers to an operation in which the system automatically outputs a message containing content such as notifications, summaries, questions, or suggestions to members of a communication group.

The term “call for attention” refers to an operation in which the system generates and transmits a message designed to attract user attention or to prompt a response or interaction from members of a communication group.

The term “terminal device” refers to an end-user computing device, including at least one of a smartphone, tablet, personal computer, or similar user interface device, that communicates with the server via the communication network.

The term “character information” refers to user-provided text content or message content, including at least one of free-form input text, chat messages, or report text, that is processed by the system for response generation.

The term “response information” refers to text or other data generated by the generative AI model and the processor as a reply to user input, configured to reflect the specified role information and language expression conditions.

The term “writing style conditions” refers to parameters specifying stylistic attributes of generated text, including at least one of narrative style, level of detail, sentence length constraints, or use of specific rhetorical forms.

The term “utterance length constraints” refers to numerical or qualitative limits on the length of generated messages, including constraints on the number of characters, words, or sentences.

The term “topic types” refers to categories of content that generated messages may address, including at least one of task topics, social topics, environmental topics, or system-defined thematic categories.

The term “base setting” refers to a stored configuration for the generative AI model, including at least one prompt sentence and associated parameters, that is automatically applied to subsequent model invocations to maintain consistent behavior.

The term “report information” refers to structured or unstructured data describing user activities, tasks, or behavior, including at least one of task content information, progress information, and behavior record information.

The term “task content information” refers to data describing the nature, identifier, status, or outcome of a work item or assignment processed by a user.

The term “behavior record information” refers to data describing user actions or sequences of actions over time, including at least one of timestamps, event types, and activity descriptions.

The term “transformed report information” refers to report information that has been reformatted or rephrased by the generative AI model according to role information and language expression conditions while preserving factual content.

The term “response history information” refers to stored records of user responses or interactions, including message content, timestamps, and associated metadata, accumulated over time for a communication group.

The term “topic candidates” refers to potential subjects or themes for future messages, derived from analysis of response history information and optionally other context data.

The term “preference tendencies” refers to inferred user or group preferences, including favored topics, styles, or options, derived from aggregated response history information.

The term “behavior style” refers to a characteristic pattern of expression or interaction, including tone, typical phrases, and interaction patterns, associated with a particular persona, fictional personality, or imagined role.

In an embodiment, a server hosts a communication support system on a computing platform that includes at least one processor, a main memory, a persistent storage device, and a network interface. The server executes a server program implemented, for example, using a general-purpose operating system, a network server framework, and a database management system. The server stores a generative AI model as a generation-type information processing model in a storage region, such as a non-volatile storage device, and loads the model parameters into the main memory at runtime.

The server uses a generative AI model implemented as a multi-layer neural network, such as a transformer-based language model. The neural network includes an embedding layer that converts discrete token identifiers into continuous vector representations, a plurality of attention layers each including multi-head self-attention mechanisms and position-wise feed-forward sub-layers, and an output projection layer that converts hidden representations into probability distributions over a vocabulary. The server stores, for each layer, weight matrices, bias vectors, and layer-normalization parameters. The generative AI model has been trained beforehand using a stochastic gradient-based optimization method, such as Adam or stochastic gradient descent with momentum, with a loss function such as cross-entropy between predicted token distributions and ground-truth token sequences. During training, the server or an external training system adjusts the model parameters by computing gradients of the loss function with respect to the parameters by back-propagation, and updates the parameters according to a predefined learning rate schedule. The server may also store information about data augmentation methods used during training, such as random masking of tokens or permutation of training examples to improve generalization.

The server loads the generative AI model into memory and maintains a model context manager module. The server receives a prompt sentence from a user via a terminal and stores the prompt sentence as a sequence of token identifiers in a structured data object together with metadata including user ID, group ID, and timestamp. The server applies a tokenizer algorithm, such as byte-pair encoding or subword segmentation, to convert each character sequence into a list of integer token identifiers. The server composes an input sequence for the generative AI model by concatenating a base prompt sentence, which provides role information and language expression conditions, with the user-provided prompt sentence, and optionally with auxiliary context tokens representing group-specific information. The server provides the composed token sequence to the generative AI model and obtains an output token sequence that is decoded into natural language text and used as generated information or response information.

The server maintains a configuration repository in a database that stores, for each communication group and for each user, role information, language expression conditions, utterance length constraints, and topic types. The server represents this configuration as structured records, for example including fields for a role identifier, a style profile identifier, maximum token length, preferred topics, and a base prompt sentence. The server uses these records to construct base prompt sentences that are automatically added to subsequent prompt sentences supplied to the generative AI model. By centralizing this configuration and automatically combining it with incoming user data, the server reduces the need for redundant prompt construction on client devices and enforces consistent persona behavior across multiple interactions.

The server maintains a communication-group management module that interacts with a communication platform through a network interface. The server registers an information processing function, which behaves as a virtual member or bot within a communication group, using group identification information such as a group ID or channel identifier. The server stores membership status and access tokens in the configuration repository. When the server generates information to be sent to the communication group, the server uses this membership information to call a communication-platform application programming interface so that the generated text is posted as if originating from the information processing function.

The server uses a scheduling module that computes times for performing information provision or a call for attention. The server uses time information obtained from a system clock and uses random number generation processing, such as a pseudo-random number generator with a specified seed, to determine time intervals and selection of topics. The server maps random values to discrete time slots and topic candidates, and generates scheduling decisions by applying an algorithm that balances frequency, diversity of topics, and historical engagement metrics. By computing these scheduling decisions centrally, the server reduces message collisions, avoids redundant prompts to inactive groups, and controls communication load on the network. This improves the efficiency of network resource usage and reduces unnecessary communication traffic.

The server accumulates response history information of users in the communication group. For each received message from a terminal, the server stores a record including at least the user identifier, group identifier, prompt identifier, response text, and timestamp. The server periodically or on-demand runs an analysis process that derives topic candidates and preference tendencies from the stored response history information. The server may use feature extraction techniques, such as keyword extraction using term frequency-inverse document frequency scores or vector embeddings generated by the same or an auxiliary neural network, to identify content features. The server clusters responses according to similarity in the feature space and records, for each cluster, topic labels and statistical measures such as frequency counts and engagement rates. By doing so, the server is able to generate prompt sentences that include explicit topics or tendencies based on empirical data rather than on ad-hoc assumptions.

The server then constructs new prompt sentences that include the extracted topic candidates or preference tendencies, along with the existing role information and language expression conditions. For example, when response history indicates that users frequently mention a specific type of meal, the server adds an instruction such as “prioritize asking about meals of type X” to the base prompt sentence. The server provides this enriched prompt sentence to the generative AI model, which produces text that is more aligned with actual user interests. Because the server uses structured historical data and algorithmic feature extraction to modify prompt sentences, the system improves the relevance and effectiveness of generated messages and reduces the number of low-engagement communications, thereby reducing wasted computational and network resources.

The server also acquires report information including task content information and behavior record information via the terminal. The server stores these reports in a structured format, such as a record containing task identifiers, completion status, timestamps, and textual descriptions. The server then combines the report information with role information as a prompt sentence. For example, the server may create a prompt sentence such as:
“You are an otherworld wizard. Rewrite the following work report in a fun, in-character style while keeping factual content accurate. Report: Completed ticket #123 and reviewed the design document.”

The server tokenizes this prompt sentence together with the report content, feeds it to the generative AI model, and obtains transformed report information in which factual content is preserved, but phrasing and style correspond to the specified role. The server stores the transformed report information in the database and distributes the transformed report information to the communication group. Because the server maintains a clear boundary between factual content fields and stylistic transformation instructions, the server can automatically verify that key identifiers and status values remain unchanged between the original and transformed reports, thereby improving output reliability.

The server uses multiple alternative implementations of the generative AI model. In one implementation, the server uses a large transformer model with many attention layers and high-dimensional embeddings to generate highly varied and contextually rich responses. In another implementation, the server uses a smaller condensed model adapted by knowledge distillation to fit into environments with limited computational capacity. In yet another implementation, the server uses a modular architecture, in which a base language model is combined with an auxiliary classifier that predicts topic relevance scores or sentiment, and the server uses the classifier's output as an additional input feature when constructing the prompt sentence or when selecting among multiple candidate outputs. By supporting these alternative architectures, the server can trade off between computational cost and quality of generated text depending on the deployment environment.

The server optionally implements a fine-tuning or continual adaptation process for the generative AI model using group-specific data. In such an embodiment, the server periodically extracts a subset of user interactions including original prompt sentences and desired responses and uses them to compute gradients of a loss function defined on discrepancies between the current model outputs and desired outputs. The server updates a subset of model parameters, such as adapter layers inserted between attention blocks or low-rank factorization matrices added to existing weight matrices, rather than updating the entire model. By limiting updates to these smaller parameter subsets, the server reduces training time and memory consumption. The server also uses regularization terms in the loss function to prevent overfitting to the group-specific data. As a result, the generative AI model becomes better adapted to the characteristics of a particular communication group without sacrificing general performance, thereby improving both response appropriateness and computational efficiency.

The server implements non-conventional procedures for prompt construction and model invocation. Instead of simply relaying user questions to the generative AI model, the server executes a multi-step prompt assembly algorithm. The server retrieves a base setting from the configuration repository, which includes stored role information, base writing style conditions, and utterance length constraints. The server then retrieves contextual modifiers derived from response history analysis and group-level behavior statistics. The server combines these elements with the immediate user input or scheduling decision. The server orders these components according to predefined rules, such as placing role instructions at the beginning, placing factual content in the middle, and placing behavioral constraints at the end. The server also normalizes token lengths by truncating low-priority context when necessary to meet utterance length constraints. This non-conventional prompt assembly algorithm ensures that the generative AI model receives a compact yet rich set of instructions aligned with system-level policies, leading to improved consistency and reduced variance in generated outputs.

The server uses this architecture to deliver technical improvements to computer operation. First, by reusing base settings and contextual modifiers stored on the server, the system reduces the amount of redundant information that must be transmitted from terminal devices for each request, thereby lowering communication bandwidth requirements. Second, by performing server-side scheduling and topic selection using random number generation and history-based algorithms, the system avoids unnecessary or overlapping messages, thereby reducing calls to the generative AI model and saving computation time and energy. Third, by maintaining structured separation between factual content and stylistic instructions and by checking consistency of key fields before distribution, the server reduces errors in generated reports and improves data integrity compared to ad-hoc or manual editing. Fourth, by using adapter-based fine-tuning and feature-based prompt conditioning, the server achieves higher relevance of generated text with fewer tokens and fewer model invocations, resulting in improved processing speed and reduced latency from the user's perspective.

The terminal provides a user interface that allows the user to specify role information, language expression conditions, and prompt sentences in a flexible manner. The terminal may be implemented as an application on a general-purpose computing device such as a smartphone, tablet, or personal computer. The terminal maintains a local user interface state, displays current character configuration including role descriptions and example utterances, and sends corresponding configuration updates to the server via the communication network. The terminal displays messages generated by the server and allows the user to input free-form text. The terminal may also provide specialized screens for entering report information, such as task lists and completion statuses.

The user uses the terminal to define or refine character behavior and dialogue style. For example, the user may input a prompt sentence such as:
“As a Kansai-dialect uncle, ask the team what they want for lunch today in a very casual and friendly way.”
or
“As an otherworld wizard, convert the following work report into a playful but accurate message: Finished code review for feature X and deployed to staging.”

The terminal transmits these prompt sentences to the server, and the server uses them to update base settings or to generate immediate responses. The user can observe the generated messages in the communication group and may adjust the prompt sentences, for example by adding instructions such as “use short sentences” or “avoid technical jargon,” to refine output style.

The server thereby controls the generative AI model in a manner that goes beyond simple automation of human text composition. The server implements a structured data pipeline, explicit configuration management, random-based and history-based scheduling, and context-aware prompt assembly aligned with stored group behavior metrics. By tailoring the generative AI model's operation through these server-side procedures and data structures, the system improves the technical functioning of the communication infrastructure, increases computational efficiency, reduces network traffic, and improves data accuracy and consistency compared to conventional stateless use of generative models.

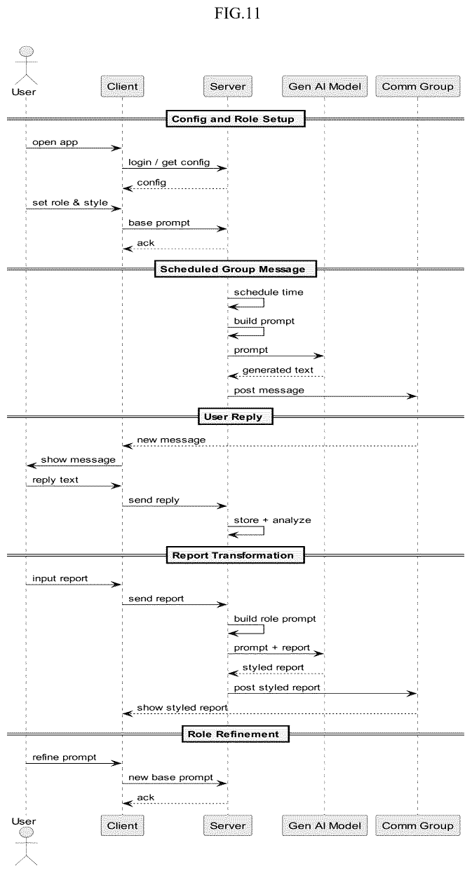

The following describes the processing flow using FIG. 11.

### Step 1:

Server initializes the communication support environment.
Server loads configuration data from persistent storage, including role information, language expression conditions, utterance length constraints, topic types, communication group identifiers, and initial base prompt sentences. As input, the server receives configuration records stored in a database. The server parses these records, converts string fields into internal data structures (such as enumerations for roles and numerical values for length constraints), and stores them in main memory or cache. As output, the server obtains in-memory configuration objects that are ready to be referenced in subsequent processing.

### Step 2:

Server loads and prepares the generative AI model.
Server reads a trained generative AI model from a storage region, including neural network weights, tokenizer vocabulary, and model configuration parameters such as number of layers and embedding dimensions. As input, the server receives model files and associated configuration metadata. The server allocates memory buffers for model parameters, initializes runtime objects for the tokenizer, and performs a self-check routine to verify checksum values and model version compatibility. As output, the server produces an initialized model instance and tokenizer instance that can accept prompt sentences and generate text.

### Step 3:

Server registers the information processing function in a communication group.
Server uses group identification information to connect to a communication platform and register a bot-like information processing function as a member of a communication group. As input, the server receives group IDs, authentication tokens, and endpoint URLs from the configuration objects. The server performs authentication by sending credential data to the communication platform API, then sends a registration or join request referencing the group ID. As output, the server obtains confirmation of membership, which it stores as a membership status record that includes group ID, bot ID, and allowed operations.

### Step 4:

Terminal initializes the user interface and establishes a session.
Terminal starts an application, loads stored user settings such as preferred language and default character, and opens a network connection to the server. As input, the terminal reads local configuration files and user identifiers from local storage. The terminal creates a session token by sending a login or registration request to the server. As output, the terminal obtains a session identifier and displays an initial screen showing available communication groups and character settings.

### Step 5:

User selects or defines a character role and style.
User operates the terminal to open a configuration screen and selects a character role, such as a regional dialect speaker or a fictional persona, and specifies style details such as level of formality and typical tone. As input, the user views lists and forms displayed on the terminal and chooses options by tapping or clicking. The terminal aggregates these selections into a prompt sentence, for example: “You are an otherworld wizard. Speak in a playful tone but keep information accurate.” As output, the terminal sends this prompt sentence and associated parameters to the server as a configuration update request.

### Step 6:

Server updates base settings for the generative AI model.
Server receives the user-defined prompt sentence and related style parameters from the terminal. As input, the server obtains a configuration payload including user ID or group ID, role information, and text of the prompt sentence. The server validates the length and content of the prompt sentence, stores it as a base setting in the configuration repository, and updates in-memory mapping tables that link groups or users to base prompts. As output, the server produces updated base configuration objects that will be automatically appended to future prompt sentences supplied to the generative AI model.

### Step 7:

Server schedules information provision and calls for attention.
Server activates a scheduling module that computes future times for generating messages. As input, the server reads current time from a system clock, retrieves group activity statistics from the database, and generates random values using a pseudo-random number generator. The server applies an algorithm that maps random numbers and activity levels to specific time slots and topic candidates, such as “lunch discussion near midday” or “daily check-in in the morning.” As output, the server records scheduled events in a schedule table, each event containing a trigger time, target group, and topic label.

### Step 8:

Server generates a prompt sentence for group activation.
Server, when a scheduled event is triggered, retrieves the corresponding base setting and topic information. As input, the server reads the base prompt sentence for the group, topic label (such as lunch or weather), and any preference tendencies previously extracted from response history. The server concatenates these elements into a new prompt sentence, for example: “As a Kansai-dialect uncle, generate one friendly question asking team members what they want for lunch today, in a casual tone.” The server may also append constraints such as “use fewer than 50 words.” As output, the server obtains a finalized prompt sentence ready for tokenization.

### Step 9:

Server tokenizes the prompt sentence and calls the generative AI model.
Server converts the prompt sentence into a sequence of tokens and feeds it to the generative AI model. As input, the server provides the text of the prompt sentence to the tokenizer, which segments the text into subword tokens and maps them to integer identifiers. The server then supplies the token sequence to the model and executes forward propagation through the neural network layers, computing attention weights, intermediate hidden representations, and output probability distributions over vocabulary tokens. As output, the server obtains a sequence of output token identifiers, which it decodes back into natural language text representing the generated message.

### Step 10:

Server posts the generated message to the communication group.
Server receives the generated natural language text from the model invocation process. As input, the server has the generated text and metadata including group ID and bot identity. The server formats the text according to the communication platform's message schema, attaches headers indicating sender and timestamp, and transmits an HTTP or equivalent API request to the communication platform. As output, the server obtains a confirmation from the platform and the message becomes visible to group members as a post from the information processing function.

### Step 11:

Terminal receives and displays the generated message.
Terminal subscribes to message events for the communication group through the communication platform or through a direct server push channel. As input, the terminal receives event notifications containing message text, sender ID, and timestamp. The terminal checks whether the sender ID corresponds to the information processing function and updates the user interface accordingly, for example by displaying a distinctive avatar and role name. As output, the terminal shows the generated message in the chat view and may also display visual indicators such as tags for the role (for example, “Wizard Mode” or “Dialect Mode”).

### Step 12:

User reads the message and inputs a response.
User observes the message provided by the AI-controlled character, such as “What do you all want to eat for lunch today?” The user then decides on a reply and enters text through a keyboard or touch interface on the terminal, for example: “I want to eat curry today.” As input, the user sees the on-screen message and uses the terminal input field. The terminal captures the raw text string and bundles it with metadata such as user ID and message reference. As output, the terminal sends this structured response payload to the server over the communication network.

### Step 13:

Server stores and analyzes the user response.
Server receives the user response payload from the terminal. As input, the server obtains the text of the user message, the user identifier, the group identifier, and optionally a reference to the triggering AI message. The server writes this data into a response history table and may apply natural language processing to extract keywords or simple sentiment features. The server computes feature vectors, such as word frequency profiles or low-dimensional embeddings produced by the tokenizer and model encoder, and stores pointers to these features in a separate analysis table. As output, the server updates the response history information that later will be used to infer topic candidates and preference tendencies.

### Step 14:

Server derives topic candidates and preference tendencies.
Server periodically or upon a trigger examines accumulated response history data for a communication group. As input, the server reads past responses, associated feature vectors, and engagement metrics such as frequency and response rate. The server executes clustering or aggregation algorithms on the feature vectors to identify commonly occurring themes, such as frequent mentions of a particular meal type or recurring topics like “weather” or “project status.” The server calculates statistics such as count, proportion, and average response length for each theme. As output, the server produces topic candidate records and preference profiles that describe what types of content the group tends to engage with.

### Step 15:

Server incorporates history-based modifiers into future prompt sentences.
Server takes the topic candidates and preference tendencies derived from history and uses them to adjust subsequent prompt sentences. As input, the server obtains base prompt sentences and the set of topic preferences, such as a higher weight for lunch topics on weekdays. The server modifies the prompt content by adding explicit instructions, for example: “Prefer to mention curry and noodle dishes, since they are often chosen by the team.” The server also adjusts model parameters or sampling parameters such as temperature and top-k values to bias generation toward preferred content. As output, the server produces enriched prompt sentences and generation settings that increase the relevance and resonance of generated messages.

### Step 16:

User submits report information via the terminal.
User uses the terminal to enter structured or free-form report information describing tasks completed or actions taken. As input, the user fills in report fields or types a sentence such as “Completed ticket 123 and reviewed the design document.” The terminal collects this information into a report payload including user ID, task identifiers, and description text. As output, the terminal transmits this payload to the server through a designated report submission interface.

### Step 17:

Server transforms report information into role-styled text.
Server receives the report payload from the terminal. As input, the server obtains task content information and behavior record information, along with associated user and group identifiers. The server retrieves the currently active role information and base prompt sentence for the group, and then constructs a combined prompt sentence, such as: “You are an otherworld wizard. Rewrite the following work report in a fun, in-character style while keeping factual content accurate. Report: Completed ticket 123 and reviewed the design document.” The server tokenizes this combined prompt sentence and feeds it into the generative AI model. As output, the server obtains transformed report information, for example: “By the power of ancient spells, I have completed ticket 123 and etched my wisdom into the design scroll.”

### Step 18:

Server validates and distributes the transformed report.
Server performs consistency checks to confirm that key factual elements, such as task IDs and completion status, remain unchanged between the original and transformed text. As input, the server compares parsed tokens from the original report and transformed report, checking for presence of specific identifiers and numeric fields. If validation passes, the server formats the transformed report and posts it to the communication group using the communication platform API. As output, the server updates the report history table with both original and transformed versions and causes the transformed report to appear in the group chat as a message from the information processing function.

### Step 19:

Terminal displays the transformed report and allows further interaction.
Terminal receives the transformed report message as part of regular message events from the communication platform. As input, the terminal obtains the message text and metadata indicating it is a work report in a particular role style. The terminal displays the transformed report along with appropriate labels, such as “Work Report (Wizard Style),” and presents reaction or reply options. As output, the terminal enables the user and other group members to respond or acknowledge the report, which generates additional user responses that flow back into the server's response history and analysis pipeline.

### Step 20:

User refines the character behavior through additional prompt sentences.
User observes the generated messages and decides to change or fine-tune the character behavior. As input, the user reads the current output on the terminal and opens the character settings interface. The user enters a new prompt sentence such as “As a Kansai-dialect uncle, propose three lunch ideas to the team in a friendly and humorous tone, using short messages.” The terminal sends this refined prompt sentence to the server. As output, the refinement request leads to updated base settings on the server, which affect subsequent prompt construction and, consequently, future outputs of the generative AI model.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional interactive customer support and guidance systems that rely on predetermined scripts or rule-based dialog engines suffer from several technical limitations. A typical system stores fixed response templates and simple branching rules, and executes these rules on a processor when a user submits input. Such systems cannot flexibly adapt linguistic style, prosody, or dialogue strategy to a user's emotional state or to dynamic conversational context. As a result, the processor often performs repetitive control flows, leading to low utilization of available computational resources and reduced effectiveness of user engagement functions.

Moreover, when generative AI models are used in a naive fashion such as directly sending user text to a model and returning the raw output, the system tends to lack fine-grained control over role impersonation, dialect selection, safety filtering, and multi-modal output formatting. In such architectures, the processor typically executes a monolithic request-response loop: receive text, call a remote model, and return generated text. This loop does not provide structured control over intermediate representations such as role information, prompt sentence construction, or post-processing, which in turn limits the technical ability of the system to generate consistent, safe, and contextually appropriate responses.

Further, existing systems rarely integrate emotion recognition into the prompt construction pipeline in a systematic way. While some implementations may detect sentiment at a coarse level, they do not maintain a machine-readable role information structure that includes a type of response role, speaker attribute, speaking style attribute, and emotion attribute, nor do they reconfigure the prompt sentence dynamically based on such role information. As a consequence, the processor cannot efficiently orchestrate the generative AI model to produce responses that are adapted to the user's current emotional state while maintaining a predetermined character persona.

In addition, many known systems do not provide a technically robust mechanism for initiating user interaction in a communication network by using generative AI-generated call messages at controlled random timings or probabilities. Without such a mechanism, the communication interface and processor generally remain idle until explicit user input is received, which reduces the effectiveness of the system's interactive capabilities and fails to exploit the generative AI model to proactively manage dialogue sessions in a networked environment.

From a computer technology perspective, there is a need for an improved system architecture and processing pipeline in which a processor cooperates with an information terminal, a communication interface, and a generative AI model to (i) convert speech to text, (ii) obtain structured natural language understanding results, (iii) construct and manage role information and prompt sentences, (iv) perform controlled post-processing of generated responses, (v) adjust character behavior based on emotion recognition, and (vi) generate and deliver network-based call messages at random timings. Such an architecture should improve the technical functioning of the conversational system itself by enabling more precise control over the generative AI model, better utilization of speech recognition and speech synthesis functions, and more efficient and flexible handling of interactive sessions in a communication network.

The specific processing by the specific processing unit 290 of the data processing device 12 in Application Example 1 is realized by the following means.

The present invention provides a server comprising a processor, a communication interface, and an information terminal interface, wherein the processor is configured to (i) receive audio data obtained by a user performing voice input via an information terminal and convert the audio data into character data by using a speech recognition function, (ii) transmit the character data to an external information processing apparatus having a natural language processing function and obtain analysis result data including intention information and attribute information from the external information processing apparatus, (iii) determine, on the basis of the analysis result data and conversation history data, role information including a type of response role, a speaker attribute, a speaking style attribute, and an emotion attribute, and generate a prompt sentence including the role information and the character data, (iv) input the prompt sentence to a generative AI model and cause the generative AI model to generate response text that impersonates the role in accordance with the role information, (v) perform post-processing on the response text, the post-processing including detection of inappropriate expressions, length adjustment, and insertion of additional information, and transmit post-processed response text to the information terminal via the communication interface, (vi) cause the information terminal to display the response text on a display, convert the response text into audio data by using a speech synthesis function, and output the audio data via an output device, (vii) use the generative AI model to generate a call message, transmit the call message to the information terminal via the communication interface at a random timing or with a random probability in a communication network, and promote initiation of a dialogue using the call message, and (viii) analyze character input or voice input from the user, estimate an emotional state by emotion recognition processing, generate a second prompt sentence in which the role information is changed in accordance with the emotional state, and input the second prompt sentence to the generative AI model to cause the generative AI model to generate response text corresponding to the emotional state. This enables an improved computer-implemented interactive dialogue system in which the processor orchestrates speech recognition, natural language understanding, structured prompt sentence construction, generative AI-based response generation, safety-oriented post-processing, emotion-adaptive role control, and randomized call message delivery, thereby technically enhancing the controllability, responsiveness, and effectiveness of the conversational functions executed in the communication network.

The term “processor” refers to a hardware or virtual computing element, such as a central processing unit or a processing core, that executes machine-readable instructions to perform data processing, control, and communication operations in the system.

The term “communication interface” refers to a hardware and/or software component that enables data exchange between the processor and external devices or networks, including wired or wireless communication modules, network adapters, and associated communication protocols.

The term “information terminal” refers to an electronic device operated by a user, such as a portable communication device or a general-purpose computing device, that includes at least an input unit, a display, and an audio output unit, and that communicates with the server via the communication interface.

The term “audio data” refers to digital data representing an acoustic signal obtained from a user, including sampled waveform data or encoded audio frames suitable for processing by a speech recognition function.

The term “character data” refers to text data encoded in a character encoding scheme, such as a sequence of symbols or code points, that represents linguistic content derived from audio data or user input.

The term “speech recognition function” refers to a software and/or hardware module that analyzes audio data to infer corresponding text content, using techniques such as acoustic modeling, language modeling, and decoding.

The term “external information processing apparatus” refers to a separate computing resource, accessible via a network, that performs natural language processing or other specialized processing on data supplied by the processor and returns analysis results.

The term “natural language processing function” refers to a function that interprets and analyzes human language text to extract structured information such as intentions, entities, attributes, or semantic relations.

The term “analysis result data” refers to structured data returned from the external information processing apparatus, including fields such as intention information, attribute information, and confidence values derived from natural language processing.

The term “intention information” refers to data indicating a type of user intention or purpose detected from user input, such as a request, inquiry, command, or preference category.

The term “attribute information” refers to data representing parameters or features associated with the user input or conversational context, including but not limited to product attributes, user profile attributes, temporal attributes, or location attributes.

The term “conversation history data” refers to stored information representing previous exchanges between the user and the system, including prior user inputs, system responses, timestamps, and associated metadata.

The term “role information” refers to machine-readable data specifying behavior characteristics of a system-generated speaker, including at least a type of response role, a speaker attribute, a speaking style attribute, and an emotion attribute.

The term “type of response role” refers to an element of the role information that indicates a functional persona or responsibility of the system-generated speaker, such as a clerk, advisor, guide, or assistant.

The term “speaker attribute” refers to an element of the role information that characterizes the identity or persona of the system-generated speaker, such as a generic person, a fictional character, a virtual personality, or a virtual entity.

The term “speaking style attribute” refers to an element of the role information that characterizes linguistic style or manner of speaking, including formality level, regional variety, dialect, lexical tendency, and tone.

The term “emotion attribute” refers to an element of the role information that represents a desired or inferred emotional state to be reflected in the generated response, such as friendliness, excitement, calmness, or sympathy.

The term “prompt sentence” refers to a text sequence supplied to a generative AI model that includes role information, user input, and optionally other contextual data, and that conditions the generative AI model to produce a desired type of output.

The term “generative AI model” refers to a machine-learned model, such as a neural network language model, configured to generate text or other data based on an input prompt sentence and internal learned parameters.

The term “response text” refers to text data generated by the generative AI model in accordance with a given prompt sentence and role information, intended to be presented to the user as part of a dialogue.

The term “post-processing” refers to operations applied to the response text after generation by the generative AI model, including detection of inappropriate expressions, length adjustment, formatting, and insertion of additional information.

The term “detection of inappropriate expressions” refers to an analysis process that examines the response text to identify content that violates safety, policy, or quality standards, such as abusive or prohibited language.

The term “length adjustment” refers to a modification process that shortens or otherwise alters the length of the response text to satisfy predetermined constraints related to display, transmission, or usability.

The term “additional information” refers to data items such as product details, promotion details, or contextual hints that are inserted into the response text during post-processing to enhance informational value.

The term “display function” refers to a function of the information terminal that renders text or graphical content on a display unit for visual presentation to the user.

The term “speech synthesis function” refers to a function of the information terminal that converts text data into audio data representing synthetic speech for playback through an audio output device.

The term “output device” refers to a hardware component of the information terminal that outputs audio to the user, such as a loudspeaker or an earphone.

The term “call message” refers to a text or audio content generated by the generative AI model that is transmitted to the information terminal for the purpose of initiating, inviting, or re-engaging a dialogue with the user.

The term “random timing” refers to a transmission timing determined at least partially based on a probabilistic or pseudo-random process rather than solely on deterministic scheduling or explicit user actions.

The term “random probability” refers to a probabilistic condition applied to decide whether or when to transmit a call message, where the decision is influenced by a random or pseudo-random variable.

The term “emotion recognition processing” refers to a computational process that analyzes user input, such as character data or audio data, to estimate an emotional state associated with the user by using signal processing, linguistic analysis, or machine learning techniques.

The term “emotional state” refers to an estimated affective condition of the user, such as satisfaction, frustration, interest, or boredom, inferred by the emotion recognition processing.

The term “second prompt sentence” refers to a prompt sentence that has role information modified in accordance with an estimated emotional state, and that is supplied to the generative AI model to generate emotion-adaptive response text.

In one embodiment, a server cooperates with a terminal and a user to implement an interactive dialogue system that generates character-based responses by using a generative AI model. The server executes a program stored in a non-transitory computer-readable medium. The program is implemented, for example, in a high-level programming language such as Python running on an operating system such as a general-purpose server operating system, and interacts with external services via network protocols such as HTTPS.

The server includes a processor and a communication interface. The processor executes modules including a speech recognition interface module, a natural language understanding interface module, a role information management module, a prompt sentence generation module, a generative AI access module, a post-processing module, an emotion recognition module, and a call message scheduling module. The server also accesses a storage device storing conversation history data, role templates, configuration data, and product or content data.

The terminal includes a processor, a microphone, a speaker, a display, a wireless communication unit, and a local storage. The terminal executes an application that communicates with the server and controls local speech recognition and speech synthesis functions. In one embodiment, the terminal uses a platform speech recognition framework, such as a mobile operating system speech framework, to convert audio captured by the microphone into text. The terminal also uses a text-to-speech engine, such as a platform speech synthesis engine, to convert received text into audio for output via the speaker.

The user operates the terminal by speaking into the microphone and by viewing and hearing responses presented by the terminal. The user can be present in a physical facility, such as a commercial facility or public space, where the terminal is used as a personal device or kiosk.

The server receives text data generated by the terminal's speech recognition function. The server then uses a natural language processing function implemented in an external information processing apparatus to analyze the text. This external apparatus may be a cloud-based natural language understanding service that implements intent classification and entity extraction. The server transmits the user text to the external apparatus using a client library or REST API, and the external apparatus returns analysis result data including at least intention information and attribute information in a structured format, such as JSON. The server parses this analysis result data and stores it in an internal data structure.

The server maintains conversation history data for each session. The conversation history is stored, for example, in a relational database management system such as a general-purpose relational database or in a key-value store. The conversation history includes previous user utterances, previous system responses, timestamps, and associated role information used in each turn. The server accesses this conversation history to provide context for generating subsequent responses.

The server uses a role information management module to represent, in a structured form, the behavior of a system-generated speaker. Role information includes at least a type of response role (for example, clerk, guide, or assistant), a speaker attribute (for example, fictional character, generic person, virtual personality, or virtual entity), a speaking style attribute (for example, formal, casual, dialectal, or childlike), and an emotion attribute (for example, friendly, enthusiastic, calm, or apologetic). The server stores role templates in a configuration database. Each role template can be represented as a record including fields such as role_type, speaker_profile, style_tags, default_emotion, and allowed_vocabulary.

The server determines role information for each user utterance based on the analysis result data and the conversation history data. For example, when the intention information indicates a product inquiry intent in a retail context, the server selects a role template corresponding to a “store clerk in a regional dialect.” The server may also inspect attribute information such as location or product category to refine the choice of role. This determination is performed by evaluating decision rules encoded in a role selection module, which may use rule-based logic, scoring functions, or a small classifier trained on metadata features. By using explicit role information in a structured form, the server improves consistency in the generated responses and reduces the computational burden of repeatedly inferring persona information from scratch at the generative AI model side.

The server uses an emotion recognition module to estimate an emotional state of the user. The emotion recognition module analyzes character data and, optionally, acoustic features derived from the original audio. In one embodiment, the server applies a recurrent or transformer-based neural network trained for text emotion classification. This network may take as input tokenized user text and output a probability distribution over emotion categories such as “satisfied,” “curious,” “confused,” or “frustrated.” The server uses a loss function such as cross-entropy during training and updates weights by gradient-based optimization such as stochastic gradient descent or Adam. Training data may include labeled conversation logs with emotion annotations. By incorporating this dedicated emotion model, the server can derive a fine-grained emotional state that would not be readily apparent from simple rule-based sentiment analysis.

The server also can incorporate prosodic or paralinguistic features if raw audio is available. For example, the server can compute features such as pitch contour, energy variance, and speech rate, and feed these features into an auxiliary neural network or concatenate them with text-based features. The emotion recognition module outputs an emotion vector that is then mapped to an emotion attribute in the role information. The server updates the role information for the current turn so that the speaking style and emotional tone of the response are adapted to the estimated emotional state.

The server uses the prompt sentence generation module to construct a prompt sentence for the generative AI model. The prompt sentence is a text sequence that encodes role information, user input, and relevant context in a structured natural language format. The server typically composes the prompt sentence by concatenating system-level instructions, role descriptions, context summaries, and the latest user utterance.

In one example, the server generates a prompt sentence such as:
“Act as a store clerk who speaks in Kansai dialect. Explain the features of the following product to the customer in a friendly and concise way. Answer only in Japanese.
Customer's question: Can you tell me about this product?
Product information: High-performance wireless earphones with water resistance and up to 8 hours of continuous playback”

In another example, the server generates a prompt sentence such as:
“As a store clerk who speaks Kansai dialect, please explain the features of the following product to the customer in a clear and friendly way. Avoid using too much polite language, and use a casual, approachable tone
Customer's question: ‘Can you tell me about this product?
Product information: ‘High-performance wireless earphones with water resistance and 8 hours of continuous playback.”

The server uses a prompt template system in which placeholders for role_type, regional_dialect, emotion_tag, and product_description are substituted with concrete values. This template-based approach improves reproducibility and reduces prompt construction errors, which leads to more stable behavior of the generative AI model and therefore a technical improvement in output consistency and safety.

The server uses the generative AI access module to send the prompt sentence to a generative AI model. In one embodiment, the generative AI model is a transformer-based neural network with multiple layers of self-attention and feed-forward sublayers. The model has been pre-trained on large text corpora using an autoregressive or masked language modeling objective and fine-tuned on instruction-following data. The generative AI model receives the prompt sentence as a token sequence, transforms each token into an embedding vector, and processes the sequence through multi-head self-attention layers. The self-attention layers compute attention weights for each token based on learned query, key, and value matrices, and the resulting contextualized embeddings are passed through position-wise feed-forward layers. At output, the model computes a probability distribution over the vocabulary for each next token conditioned on the previous tokens. During inference, the server configures generation parameters such as temperature, top-p (nucleus sampling), maximum token length, and repetition penalties. The server receives generated tokens incrementally and reconstructs them into response text.

The server improves computational efficiency by reusing conversation context as compact summaries rather than sending the entire history to the generative AI model. The server can maintain a rolling summary of the dialogue in an internal representation, such as a compressed text paragraph or a vector embedding, and insert this summary into the prompt sentence. This reduces the number of tokens that must be processed by the generative AI model for each request, which directly decreases computation time and network bandwidth usage.

The server performs post-processing on the response text. The post-processing module includes at least an inappropriate expression detection unit, a length adjustment unit, and an additional information insertion unit. The inappropriate expression detection unit can be implemented as a classifier that scans the generated text for content matching prohibited categories or as a rule-based filter that uses pattern matching and keyword lists. The length adjustment unit ensures that the output remains within constraints suitable for display on small screens and for speech synthesis duration; for example, the unit may truncate overly long responses or split them into multiple segments. The additional information insertion unit retrieves relevant structured data, such as product price, stock status, or store hours, from the server's database and embeds it into the response text while maintaining the selected speaking style.

The terminal receives the post-processed response text and uses the display to present it to the user in a conversational user interface. The terminal then invokes a speech synthesis function to convert the text into audio data. The speech synthesis function may be based on a concatenative, parametric, or neural text-to-speech model. In one embodiment, a neural TTS system uses an encoder-decoder architecture with attention, where the encoder processes text symbols into embeddings and the decoder generates a mel-spectrogram, followed by a vocoder network that converts the spectrogram into a waveform. The terminal configures voice parameters such as pitch, speaking rate, and timbre based on the role information; for instance, when the role information specifies a lively clerk persona, the terminal may use a brighter timbre and a slightly faster speaking rate. This mapping from role attributes to TTS parameters is defined in a configuration table that the terminal accesses at runtime.

The server uses the call message scheduling module to generate call messages using the generative AI model and to transmit these messages at random timings or according to random probabilities. The server maintains a scheduling data structure that includes, for each user or terminal, a next-eligibility time and a base probability. When the server detects that the terminal is online and eligible, the server generates a random number from a pseudo-random number generator and compares it with the base probability. If the random number satisfies a predetermined condition, the server constructs a prompt sentence that asks the generative AI model to generate a call message consistent with a selected role. For example, the prompt sentence may be:
“Act as a friendly store clerk who speaks casually. Create a short call message in Japanese to invite the customer to ask about current promotions.”

The generative AI model returns a call message text, and the server transmits this text to the terminal. By using random timing and probability, the server avoids predictable and repetitive patterns of call message transmission, which can lead to user fatigue. The scheduling logic also distributes workload over time, which can reduce peak network traffic and processing congestion, thus providing a technical benefit at the system level.

The server uses the emotion recognition output to adapt role information for subsequent turns. When the emotion recognition module detects, for example, that the user is frustrated, the server can automatically change the emotion attribute to “calm and apologetic” and adjust the speaking style attribute to become more formal and explanatory. The server then generates a second prompt sentence that reflects these updated attributes, so that the generative AI model produces a response with a different tone and style. By controlling the generative AI model through structured role information and dynamically updated prompt sentences, the server implements a non-conventional control mechanism that is different from simple rule-based template selection or static persona configuration. This mechanism enables more precise and efficient adaptation to user state while minimizing changes to the underlying generative AI model.

The system configuration and processing flow provide several technical effects beyond mere automation of human tasks. By offloading speech recognition and natural language understanding to specialized modules and using structured role information and emotion vectors, the server reduces the complexity of prompt engineering at runtime and prevents redundant computation. The summarization of conversation history lowers the token length sent to the generative AI model, which in turn reduces latency and server-side compute consumption. The explicit post-processing pipeline with content filtering and length control enhances reliability and safety without requiring retraining of the generative AI model. The emotion-aware role adaptation improves response relevance and can reduce the number of conversational turns needed to satisfy user requests, which indirectly reduces communication load and processing time.

The server improves the functioning of the computer system itself by enabling modularization and orchestration of different AI components. The system uses a dedicated emotion recognition network and a generative language model together in a non-conventional pipeline where the emotion output serves as a control signal to a separate prompt generation process. This division of labor differs from conventional monolithic models and allows independent optimization of each component. For example, the emotion recognition network can be comparatively lightweight and can run at high frequency, while the generative AI model can be invoked less frequently with more carefully constructed prompts. This arrangement reduces overall computational cost and yields improved responsiveness under constrained hardware resources.

In another embodiment, the server incorporates alternative neural network architectures for the generative AI model, such as encoder-decoder transformers for dialogue generation, or uses a mixture-of-experts framework where different submodels specialize in different speaking styles or content domains. The role information can be used to select or weight the appropriate expert model. This architecture further enhances control and efficiency, as only a subset of the full model capacity may be activated for each request.

In another embodiment, the terminal performs some of the natural language understanding or emotion recognition locally when sufficient hardware capabilities are available. For instance, the terminal can run a compact transformer model for sentiment classification on-device, reducing the need to transmit all user inputs to the server. This on-device processing decreases network load and can lower server-side latency, while the server still manages role information and prompt sentence construction to maintain global consistency.

In yet another embodiment, the server uses different data structures and algorithms for storing and retrieving conversation history, such as a ring buffer or a compressed sequence representation, to limit memory usage and accelerate context retrieval. The server can apply hashing or indexing mechanisms to quickly access relevant portions of the history. By organizing data structures this way, the system minimizes overhead and contributes to the overall performance improvement of the interactive dialogue system.

The system, by combining server-controlled role information management, emotion-aware prompt sentence generation, modular AI components, and hardware-level integration with microphones, speakers, and displays, achieves a technical improvement in how computer systems handle conversational interactions. The system does not merely automate human conversational behavior; rather, it introduces a structured control layer and specialized AI modules that result in more efficient processing, improved output quality, reduced latency, and optimized use of network and computing resources.

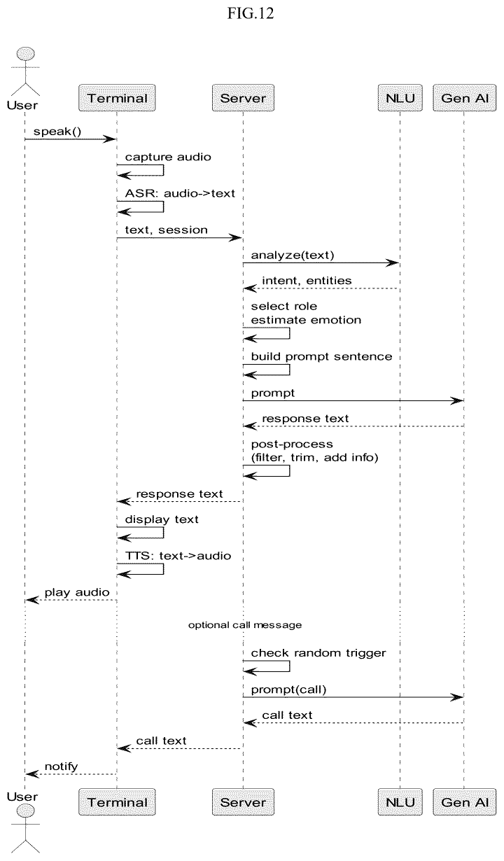

The following describes the processing flow using FIG. 12.

### Step 1:

The user operates the terminal to start an interactive dialogue application.
The user provides voice input as an analog audio signal by speaking into a microphone of the terminal.
The terminal receives this analog signal as input, samples it at a predetermined sampling rate, and converts it into digital audio data (for example, 16-bit PCM frames).
The terminal stores the resulting audio frames in a buffer in main memory as the output of this step.

### Step 2:

The terminal invokes a speech recognition function to convert the buffered audio data into text.
The terminal supplies the buffered audio frames as input to an automatic speech recognition engine, which may be implemented by a platform speech API or an external speech recognition service.
The terminal causes the ASR engine to perform feature extraction (such as MFCC calculation), acoustic model inference (such as deep neural network evaluation), and language model decoding to produce a character string corresponding to the spoken utterance.
The terminal receives recognized text (for example, “Can you tell me about this product?”) as output and stores it as character data in a Unicode string.

### Step 3:

The terminal packages the recognized text together with session information and device metadata.
The terminal uses, as input, the character data generated in Step 2, a session identifier, a user identifier (if available), and device parameters such as terminal type and language setting.
The terminal constructs a structured message, for example a JSON object, that includes fields for the recognized text, session ID, timestamp, and device information.
The terminal outputs this structured message and transmits it to the server via a communication interface using an HTTPS request.

### Step 4:

The server receives and validates the structured message from the terminal.
The server takes, as input, the HTTPS request body containing the structured message.
The server parses the message, verifies that required fields such as text, session ID, and timestamp are present and well-formed, and discards or flags malformed requests.
The server outputs a validated text string, a session context object, and an associated metadata record, which are stored in working memory and optionally logged in a database.

### Step 5:

The server forwards the validated user text to an external information processing apparatus for natural language understanding.
The server uses, as input, the validated text string and session context from Step 4.
The server calls a natural language processing API by transmitting the text, language code, and session identifier over a network, and requests intent classification and entity extraction.
The external apparatus returns analysis result data, and the server outputs a structured object containing intention information, attribute information, and confidence scores.

### Step 6:

The server determines role information for the current dialogue turn.
The server uses, as input, the analysis result data from Step 5, conversation history data retrieved from storage, and a role template database.
The server evaluates decision rules or a lightweight classifier on the intention information, attribute information, and past role selections, and selects or modifies a role template that specifies a type of response role, a speaker attribute, a speaking style attribute, and an emotion attribute.
The server outputs a role information object that includes fields such as role_type, speaker_profile, style_tags, and emotion_tag for use in subsequent processing.

### Step 7:

The server estimates an emotional state of the user and updates the role information.
The server uses, as input, the current user text, optional acoustic features derived from the original audio, and, if available, prior emotion estimates.
The server applies an emotion recognition model, for example a neural network that receives tokenized text and optional prosodic features and outputs probabilities over emotion classes.
The server computes an emotion label or vector by selecting the highest-probability class or by thresholding.
The server then modifies the emotion attribute in the role information object to reflect the estimated emotional state (for example, “calm and supportive” when frustration is detected).
The server outputs an updated role information object incorporating the emotion adjustment.

### Step 8:

The server generates a prompt sentence for a generative AI model.
The server uses, as input, the updated role information from Step 7,the current user text from Step 4, and relevant context extracted from the conversation history, such as a summary of previous exchanges.
The server injects these values into a prompt template by substituting placeholders for role description, speaking style, emotion tag, and contextual product or content information. The server concatenates system-level instructions with natural language descriptions and the user's latest utterance.
The server outputs a complete prompt sentence, for example:
“Act as a store clerk who speaks in Kansai dialect. Explain the features of the following product to the customer in a friendly and concise way. Answer only in Japanese.
Customer's question: Can you tell me about this product?
Product information: Product information: ‘High-performance wireless earphones with water resistance and 8 hours of continuous playback”

### Step 9:

The server requests response generation from the generative AI model using the prompt sentence.
The server uses, as input, the prompt sentence from Step 8 and generation parameters such as temperature, top-p, maximum output length, and language specification.
The server transmits the prompt and parameters to a transformer-based generative AI model via an API. The generative AI model tokenizes the prompt, applies multiple layers of self-attention and feed-forward computation, and computes a probability distribution for each subsequent token. Based on the configured sampling parameters, the model generates a sequence of output tokens that are then detokenized into text.
The server receives and outputs response text that impersonates the selected role and conforms to the prompt sentence constraints.

### Step 10:

The server performs post-processing on the generated response text.
The server uses, as input, the raw response text from Step 9 and policy configuration data specifying content restrictions, maximum length, and insertion rules for additional information.
The server applies a content filter that scans the response text for prohibited terms, patterns, or categories, and either replaces, removes, or flags unacceptable segments. The server then checks the length of the text and truncates or restructures it if it exceeds a predetermined limit. The server may also access a data source, retrieve structured information such as price or availability, and merge this information into the response text while preserving the selected speaking style.
The server outputs sanitized and length-controlled response text, which is prepared for delivery to the terminal.

### Step 11:

The server sends the post-processed response text to the terminal.
The server uses, as input, the final response text and the session identifier.
The server constructs a response message, for example a JSON object that includes the response text, optional display hints, and role metadata, and transmits this message to the terminal via the communication interface over HTTPS.
The terminal receives this message and outputs the extracted response text and associated metadata to its local application logic.

### Step 12:

The terminal displays the response text and performs speech synthesis.
The terminal uses, as input, the response text and any role-related metadata indicating desired tone, speaking speed, or voice characteristics.
The terminal renders the text in a chat-style interface on the display and invokes a text-to-speech engine, passing the text and configuring parameters such as pitch, rate, and voice profile based on the role information (for example, casual, lively voice for a friendly clerk). The TTS engine converts the text into an audio waveform by running its internal acoustic and vocoder models.
The terminal outputs synthesized audio through the speaker and shows the text on the screen so that the user can both hear and see the response.

### Step 13:

The server optionally generates and schedules a call message using the generative AI model.
The server uses, as input, session metadata such as last interaction time, user engagement indicators, and a random number produced by a pseudo-random number generator.
The server compares the random number with a predefined probability threshold and, when the condition is satisfied, constructs a prompt sentence instructing the generative AI model to produce a short, role-consistent call message that invites the user to interact. The server sends this prompt to the generative AI model, receives generated call message text, and transmits it to the terminal as a notification or displayable message.
The terminal outputs the call message as text and/or synthesized speech, thereby encouraging the user to provide new input and re-enter the processing loop.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented communication systems that utilize language generation models typically operate in a linear, user-by-user fashion: a user inputs a simple instruction, the system forwards this instruction as-is to a language model, and the generated text is immediately returned to the same user or channel. Such systems generally lack an architecture that (i) systematically structures prompt sentences with reusable character templates, (ii) coordinates distribution of generated messages across shared communication channels, and (iii) transforms business report texts into character-styled outputs while preserving factual content. As a result, these systems neither effectively support consistent, role-based personas across multiple interactions nor provide a robust mechanism for integrating such personas into collaborative work reporting workflows.

From a computer-technology standpoint, existing systems fail to optimize how prompt sentences and context are managed and reused on the server side. In many deployments, character description data, user prompts, and channel routing information are handled in an ad hoc manner at the client or application-script level, leading to duplicated processing, inconsistent persona behavior, and increased network and processing overhead. The server is not systematically configured to generate structured instruction information combining template information and user prompt sentences, nor to manage post-processing and channel-based distribution as distinct, coordinated processing stages. This causes inefficiencies such as repeated and redundant prompt construction, difficulty in enforcing content policies, and lack of centralized control over how generative AI outputs are integrated into multi-user communication environments.

Furthermore, conventional systems do not provide a server-centric mechanism that takes raw business report text from multiple users in a shared channel and consistently transforms the text into character-impersonated reports using a generative AI model. There is typically no standardized process that associates business report inputs with persona-defining templates, generates instruction information for the model, receives the transformed text, and redistributes it to communication channels with appropriate metadata. This makes it difficult to build communication tools in which a character persona reliably “speaks on behalf of the team” in a way that is technically scalable, auditable, and controllable.

Accordingly, there is a need for an improved computer-implemented system in which a server is specifically configured to (i) receive character selection information and prompt sentences from user terminals, (ii) generate structured instruction information by combining persona templates with the prompt sentences, (iii) interact with a generative AI model to generate character-style text, (iv) perform post-processing and centralized channel routing of the generated text, and (v) similarly process business report texts into character-styled reports. Such a configuration improves the way computers manage prompt composition, model interaction, and multi-user distribution, thereby enhancing the technical efficiency, consistency, and controllability of generative AI-based communication services.

The specific processing by the specific processing unit 290 of the data processing device 12 in Example 2 is realized by the following means.

The present invention provides a server comprising a processor configured to receive, from a user terminal, input information including character selection information and a prompt sentence, and to generate generation instruction information by combining template information defining attributes of a character with the prompt sentence on the basis of the input information; to generate a message sequence including the generation instruction information, to transmit the message sequence to a generative AI model disposed externally or internally, and to acquire generated text that imitates wording and tone of the character by text generation processing executed by the generative AI model; to perform post-processing on the acquired generated text, the post-processing including at least one of length limitation, prohibited word determination, and content formatting, to store the post-processed generated text in association with distribution destination information of a communication channel shared within a group, and to transmit the post-processed generated text to the communication channel; to receive, from the communication channel, text information including a business report text, to generate report instruction information by combining the text information with the template information defining the attributes of the character, to transmit the report instruction information to the generative AI model so as to cause the generative AI model to generate a business report text in which the character is impersonated, and to redistribute the generated business report text to the communication channel; and to transmit and receive user interface information to and from the user terminal, the user interface information relating to character selection, input of the prompt sentence, and input of the business report text, and to control display and input operations on the user terminal. This enables centralized and structured prompt construction, efficient interaction with the generative AI model, and coordinated distribution of character-impersonated messages and business reports across shared communication channels, thereby improving the technical operation of computer-based communication and reporting systems.

The term “system” refers to a computer-implemented arrangement including at least one server device, at least one user terminal, and one or more communication channels that cooperate to perform information processing, text generation, and message distribution.

The term “processor” refers to a hardware processing unit, such as a central processing unit or a programmable processing circuit, configured to execute program instructions to perform data processing, control operations, and communication control in the system.

The term “user terminal” refers to an information processing apparatus operated by a user, such as a personal computer, a mobile terminal, or another client device, that transmits input information to the server and receives generated text and interface information from the server.

The term “input information” refers to information transmitted from the user terminal to the server, including at least character selection information and a prompt sentence, and optionally including user identifiers, channel identifiers, and additional control parameters.

The term “character selection information” refers to information indicating a selected character persona, such as a particular role, personality, or speaking style, that is to be impersonated in generated text.

The term “prompt sentence” refers to a natural language instruction or request provided by a user, which is used as at least part of the input to a generative AI model for generating text.

The term “template information” refers to predefined data defining attributes of a character, including at least one of tone, wording style, behavioral guidelines, or role description, which is combined with a prompt sentence to form instruction information for a generative AI model.

The term “generation instruction information” refers to structured information generated by the processor by combining template information with a prompt sentence, the structured information being used as an input for causing a generative AI model to generate text.

The term “message sequence” refers to an ordered collection of one or more message elements, such as system messages and user messages, that together represent the generation instruction information provided to a generative AI model.

The term “generative AI model” refers to a machine learning model configured to generate text based on input information, the model typically being implemented as a statistical or neural network model and capable of producing human-like natural language output.

The term “text generation processing” refers to processing executed by the generative AI model in which input information, including the generation instruction information, is transformed into output text according to learned parameters of the model.

The term “generated text” refers to text output produced by the generative AI model in response to the generation instruction information, including text that imitates wording and tone of a character.

The term “post-processing” refers to processing performed by the processor after receiving the generated text from the generative AI model, including at least one of length limitation, prohibited word determination, content formatting, and metadata attachment.

The term “length limitation” refers to a process of constraining the number of characters, words, or tokens in generated text by truncation, summarization, or other methods in order to conform to predefined size limits.

The term “prohibited word determination” refers to a process of analyzing generated text to detect the presence of predetermined disallowed words, expressions, or categories of content, and optionally modifying, masking, or rejecting the text based on the analysis.

The term “content formatting” refers to a process of adjusting the layout or structure of generated text, including at least insertion of line breaks, bullet points, or markup, to make the text suitable for display or transmission.

The term “communication channel” refers to a logical or physical pathway for exchanging messages among multiple users or devices, such as a chat room, group message thread, or shared workspace in a communication system.

The term “distribution destination information” refers to information indicating a target communication channel, group, or recipient set to which generated text should be transmitted.

The term “group” refers to a plurality of users or terminals that share access to a common communication channel for exchanging messages and business reports.

The term “business report text” refers to text describing work status, completed tasks, progress, or other business-related information, which is input by a user or generated by the system for reporting purposes.

The term “text information” refers to information including at least one text string, such as a business report text or other user-generated or system-generated messages, received or transmitted by the server.

The term “report instruction information” refers to structured information generated by the processor by combining text information, including business report text, with template information defining attributes of a character, the structured information being used as an input for causing a generative AI model to generate a character-impersonated business report text.

The term “character is impersonated” refers to a state in which generated text is produced to reflect wording, tone, and style associated with a selected character persona, as defined by template information, while conveying substantive content derived from input information.

The term “redistribute” refers to the act of transmitting, by the processor, generated text such as a character-impersonated business report text back into one or more communication channels after processing by the generative AI model.

The term “user interface information” refers to information exchanged between the server and the user terminal to control display elements and input elements, including information relating to character selection, prompt sentence input, and business report text input.

The term “display and input operations” refers to operations on the user terminal that present visual or other outputs to the user and receive inputs from the user, including rendering of messages and reception of character selections, prompt sentences, and business report texts.

In one embodiment, a server, a plurality of terminals, and one or more communication networks constitute a system that implements the claimed invention. The server includes at least one processor, a main memory, a non-volatile storage device, and a network interface card. The server is realized, for example, as a general-purpose computing platform such as a rack-mounted server machine equipped with one or more multi-core central processing units and, in some embodiments, one or more graphics processing units. The terminals are implemented as personal computers, tablet devices, or mobile communication devices, each including a display device, an input device such as a keyboard or touchscreen, a memory, and a communication interface. The communication network is realized as a packet-based network such as a local area network or a wide area network, typically using TCP/IP over wired or wireless links.

The server stores, in the non-volatile storage device, program modules including at least a communication control module, a prompt-processing module, a template-management module, a model-interface module, a post-processing module, and a channel-routing module.
The server loads these modules into the main memory and executes them with the processor. The terminals execute a client application or web browser that presents user interface components for character selection, prompt sentence input, and business report input. The client application is implemented, for example, using a web framework or a native application framework.

The server stores a set of character templates in the storage device. Each character template is associated with a character identifier and includes template information that defines attributes of a character. The template information specifies at least a tone (for example, formal or casual), word usage patterns (for example, preference for certain interjections or dialectal expressions), and behavioral guidelines (for example, encouraging, humorous, or authoritative). The template information is stored as a structured data record, such as a key-value mapping where keys identify attribute types (tone, dialect, role, etc.) and values specify concrete parameters or phrases to be inserted into instructions.

The server receives, through the network interface, character selection information and a prompt sentence from a terminal. The terminal displays a character selection list on a display device and allows a user to choose a character persona such as “a middle-aged person speaking in a regional dialect,” “a wizard from another world,” “a strict but kind teacher,” or “a cheerful space captain.” The terminal also displays a text input field where the user inputs a prompt sentence. Example prompt sentences include:
“Act as a middle-aged person speaking in a Kansai-style dialect and propose today's lunch.”
“As a wizard from another world, create a status report for the following tasks: fixing bug number 123, updating documentation, and attending the project meeting.”
“Act as a cheerful space captain and encourage the team to submit their weekly reports.”
“As a strict but kind teacher, summarize today's completed tasks in three bullet points.”

The terminal sends the selected character identifier and the prompt sentence to the server. The server parses the received data and identifies the associated character template using the character identifier. The template-management module retrieves, from the storage device, the template information that defines attributes of the selected character. The prompt-processing module then combines the template information with the prompt sentence to generate generation instruction information. In one embodiment, the generation instruction information is represented as an ordered sequence of text segments, where one segment corresponds to character-defining instructions derived from the template information and another segment corresponds to the user-provided prompt sentence.

The server structures the generation instruction information as a message sequence suitable for input to a generative AI model. In one embodiment, the server represents the message sequence as a list of role-labeled messages, such as a “system” message containing character-defining content and a “user” message containing the prompt sentence. The server normalizes the text by performing operations such as trimming whitespace, converting line endings to a uniform format, and escaping characters that could interfere with protocol parsing. In some embodiments, the server also computes a complexity score or length estimate of the message sequence to select appropriate model parameters such as maximum output length.

The server interacts with a generative AI model using the model-interface module. The generative AI model is realized, for example, as a transformer-based neural network trained on large-scale text data. The generative AI model includes an input embedding layer, a plurality of self-attention and feed-forward layers, and an output projection layer. The server sends the message sequence and model parameters such as temperature, top-k or top-p sampling parameters, and maximum output token count to the generative AI model. The generative AI model tokenizes the input text into subword units, computes attention weights across token positions, and propagates activations through multiple layers to predict a probability distribution over the next token at each time step. The model then generates a sequence of tokens that is converted back into output text.

In one embodiment, the server accesses the generative AI model via a model-execution service running on another server equipped with specialized hardware such as graphics processing units or tensor processing units. The server transmits the input message sequence via a network interface using a defined application programming interface. The model-execution service performs the forward pass of the neural network and returns the generated token sequence as text. The server thus utilizes a dedicated computing resource optimized for matrix operations to achieve higher throughput and lower latency than would be possible with a single general-purpose processor.

The server obtains the generated text from the generative AI model and processes it with the post-processing module. The post-processing module enforces length limitation by truncating the text when the number of characters or tokens exceeds a predefined threshold. The post-processing module performs prohibited word determination by comparing words or phrases in the generated text against one or more lists of disallowed expressions. The comparison is implemented as an efficient lookup using data structures such as trie trees or hash tables to minimize computational cost. If a prohibited word is detected, the module replaces the word with a masking token or flags the text for rejection. The post-processing module also performs content formatting by inserting line breaks, bullet points, and other layout elements based on rules derived from the selected character template and the type of content (for example, suggestion, announcement, or report). The combination of these operations results in generated text that is safe for display, conforms to channel policies, and is formatted for readability.

The server associates the post-processed generated text with distribution destination information of a communication channel. The channel-routing module maintains a mapping between user identifiers and channel identifiers, as well as a mapping between character personas and default channels. The server stores, in the storage device, the association of the generated text with metadata including the channel identifier, timestamp, user identifier, and character identifier. This structured storage enables efficient retrieval for audit, search, or further analysis. The server then transmits the generated text, along with necessary metadata, to the relevant communication channel. In one embodiment, the server interfaces with an external communication platform that provides application programming interfaces for posting messages into group channels. In another embodiment, the server operates its own message distribution subsystem using publish-subscribe mechanisms or web socket connections.

The terminal receives the generated text from the communication channel and displays it in a conversation view. The terminal renders the text with an indicator such as a bot name or avatar corresponding to the character persona. The terminal may additionally display content controls such as reaction buttons or reply fields. By centralizing the generation and distribution of character-style messages at the server, the system maintains consistent character behavior across all terminals and channels, rather than relying on each terminal to construct its own prompts.

The server also processes business report texts. The terminal presents a dedicated input field for business reports, allowing the user to enter factual information such as completed tasks, ongoing work, or meetings attended. An example of a user-entered business report text is:
“Completed code review for feature X, fixed bug number 234, and attended the sprint planning meeting.”

The terminal transmits the business report text and an associated character identifier to the server. The server receives the text information including the business report text and combines it with the template information for the selected character to generate report instruction information. In one embodiment, the report instruction information includes an instruction that requires preservation of factual content while transforming the style, for example by explicitly listing task names and identifiers as immutable tokens. The server then structures the report instruction information into a message sequence and transmits it to the generative AI model.

The generative AI model generates a character-impersonated business report text. For the example above, when the selected character is a wizard from another world, the generated text may be:
“By the power of ancient code scrolls, I have completed the review of feature X, banished the bug numbered 234, and gathered with the council in the sprint planning conclave.”

The server performs the same post-processing as described above, including length limitation and prohibited word determination, and stores the character-impersonated business report text in association with channel metadata. The server then redistributes the text to the corresponding communication channel, where multiple users can view it on their terminals.

The described architecture produces technical effects beyond mere automation of human writing. The server's generation of structured instruction information by combining character templates with prompt sentences reduces redundancy in prompt construction and ensures that persona attributes are consistently applied. This eliminates the need for each terminal to assemble complex prompts and thereby reduces network traffic and client-side processing.

The use of centralized template information also enables the server to cache and reuse preprocessed template segments, improving processing throughput for repeated character selections.

The server improves data management by storing generated texts and their associated metadata in structured form, enabling efficient indexing and retrieval operations. The use of strict, predefined data structures for generation instruction information, report instruction information, and message sequences allows the server to perform validation and optimization procedures that would not be feasible if prompts were only free-form text. For example, the server can analyze instruction information to adapt model parameters such as maximum output length or sampling strategy based on message type or channel properties, thereby reducing unnecessary computation and improving response times.

The system further improves computational efficiency by controlling the interaction with the generative AI model at the server level. The server aggregates multiple user requests and can schedule them in batches, enabling the model-execution service to process several message sequences in parallel on accelerator hardware. The model-interface module can also select among models of different sizes based on the complexity of the instruction information, thereby balancing accuracy and resource consumption. This dynamic selection is based on rules or learned metrics stored on the server and not dependent on user input, which contributes to reduced latency and lower operational cost.

The generative AI model itself is trained using a supervised or semi-supervised learning method on a corpus of text data. The model is optimized by minimizing a loss function such as cross-entropy between predicted token distributions and ground-truth tokens. During training, a parameter update algorithm such as stochastic gradient descent or an adaptive variant adjusts weight parameters of the neural network based on gradients computed via backpropagation. Data augmentation techniques such as random masking, sentence re-ordering, and style transformations may be used to improve generalization. As a result, the trained model can capture relationships between persona instructions and output style, which enables the server to generate text that reliably imitates specified characters.

The system differs from human work in that the server enforces a non-human, rule-based approach to persona control. Instead of relying on a human author to remember and apply character traits, the server encodes these traits in template information and systematically combines them with prompt sentences and business report texts according to a predetermined data flow. The server applies algorithmic checks, such as prohibited word determination using machine-readable lists and pattern matching, to maintain compliance with policies. In addition, the server can apply consistency checks to ensure that critical business identifiers (such as task IDs or bug numbers) are preserved in the generated text by comparing token sequences before and after generation. This machine-based verification process is distinct from human editing and leads to lower error rates and higher reliability for business-critical reporting.

The system also reduces communication load within the network. By centralizing persona and formatting logic at the server, the terminals transmit only essential data such as character identifiers and short prompt sentences, rather than long, repetitive character descriptions. The server then handles expansion into full instruction information near the model-execution environment, minimizing the number of bytes transferred over wide-area links. This architecture is particularly advantageous when the generative AI model is hosted in a data center different from the users'locations, because it reduces the size of uplink and downlink messages between terminals and the server.

In alternative embodiments, the server may host multiple generative AI models specialized for different languages or domains. The template-management module can select a particular model based on factors such as the language attribute of the prompt sentence or the type of business report. The server can also maintain separate sets of template information for different organizations or teams, enabling customized persona behaviors without altering the underlying model. In another variation, the post-processing module may incorporate statistical or rule-based summarization to produce condensed versions of generated texts for display on resource-constrained terminals, thereby further reducing bandwidth and processing requirements.

In still another embodiment, the terminals can operate in an offline or intermittently connected mode. The server then synchronizes character templates, partial logs, and cached model outputs when connectivity is available. The data structures and algorithms described above allow this synchronization to be performed in a differential manner, transmitting only changes in templates, instruction information, and message histories. This approach further improves network efficiency and enables robust operation in environments with unstable connectivity.

Through these configurations, the server, the terminals, and the generative AI model cooperate in a manner that improves the internal operation of the computer system itself. The system enhances how prompts are composed, how text generation is parameterized and controlled, how data is structured and stored, and how messages are routed and displayed across multiple users and devices. This yields technical effects such as improved processing speed, better consistency and accuracy in persona-driven text outputs, reduced communication overhead, and enhanced manageability of generated content, beyond what could be achieved by merely automating human writing without the described server-centric architecture and data structures.

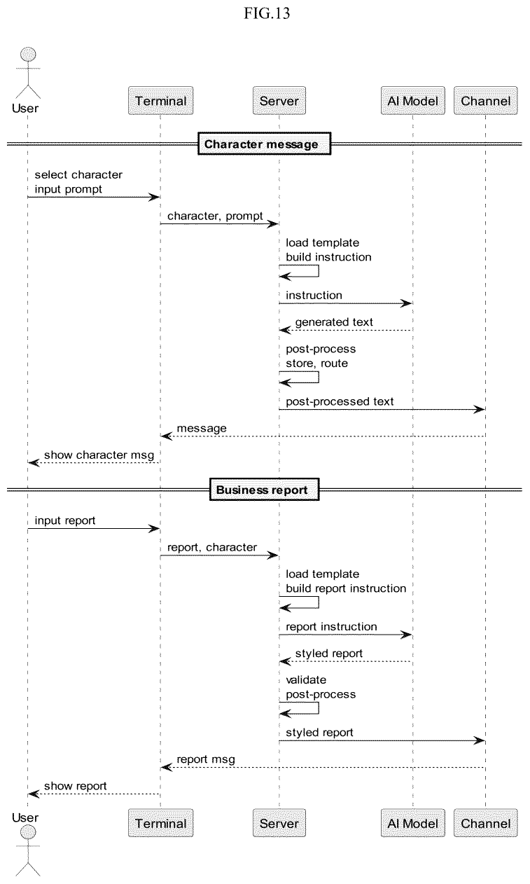

The following describes the processing flow using FIG. 13.

### Step 1:

The terminal displays a user interface for character selection and prompt sentence input.
The user selects a character persona from a list and inputs a prompt sentence such as “Act as a middle-aged person speaking in a Kansai-style dialect and propose today's lunch.”
The terminal takes, as input, the user's selection operation and keyboard or touch input, converts the selected character into a character identifier and the typed text into a prompt sentence string, and outputs a structured request including the character identifier, the prompt sentence, and a user identifier to the server via a communication network.

### Step 2:

The server receives the structured request from the terminal.
The server takes, as input, the user identifier, the character identifier, and the prompt sentence string, parses the request, and validates that the prompt sentence length and character identifier format meet predefined constraints.
The server outputs an internal normalized record containing the user identifier, the validated character identifier, and the sanitized prompt sentence to a prompt-processing module.

### Step 3:

The server retrieves template information corresponding to the character identifier.
The server takes, as input, the character identifier from the normalized record, executes a lookup operation in a template storage structure such as a key-value store or relational table, and reads template attributes including tone, wording patterns, and behavior guidelines.
The server outputs the retrieved template information together with the original prompt sentence as a combined data set to the prompt-processing module.

### Step 4:

The server generates generation instruction information by combining the template information with the prompt sentence.
The server takes, as input, the template information and the prompt sentence, concatenates character-defining text segments with the user's instruction, assigns roles such as “system” and “user” to the respective segments, and constructs a message sequence data structure.
The server performs data operations including string concatenation, insertion of control tokens, and normalization of line breaks, and outputs the resulting generation instruction information as a message sequence suitable for a generative AI model.

### Step 5:

The server prepares and transmits a request to the generative AI model.
The server takes, as input, the message sequence, encodes the text into a token sequence using a tokenizer, and attaches model control parameters including temperature, maximum token count, and sampling strategy.
The server packages these elements into a model request object and outputs the request via a network interface to a model-execution service that hosts the generative AI model.

### Step 6:

The generative AI model generates character-style text from the message sequence.
The server receives, as input, tokenized results and configuration parameters at the model-execution service, where a neural network performs numerical operations: embedding lookup, multi-head self-attention, matrix multiplications in feed-forward layers, and softmax-based probability computations at each decoding step.
The model converts the sequence of predicted tokens into output text that imitates the character's wording and tone, and outputs the generated text as a response to the server.

### Step 7:

The server post-processes the generated text.
The server takes, as input, the raw generated text from the generative AI model, calculates its length in characters or tokens, and applies a length limitation operation by truncating excess content beyond a threshold.
The server performs a prohibited word determination by scanning the text against a data structure such as a hash set or trie of forbidden expressions; when a match is found, the server replaces or masks the matched segments.
The server then performs content formatting by inserting line breaks, bullet markers, or prefixes according to formatting rules derived from the template information.
The server outputs a post-processed generated text string and associated metadata including character identifier, user identifier, and timestamp.

### Step 8:

The server associates the post-processed generated text with a communication channel and stores it.
The server takes, as input, the post-processed generated text and metadata, determines a distribution destination by consulting a routing table that maps user identifiers and character identifiers to channel identifiers, and creates a message record that includes text and channel information.
The server writes this message record into a persistent storage structure, such as a message history table, and outputs a distribution instruction containing the channel identifier and the message content to the channel-routing module.

### Step 9:

The server transmits the generated character message to the communication channel.
The server takes, as input, the distribution instruction, formats a request compatible with an external communication platform or an internal messaging backend, and inserts fields such as sender name representing the character persona and the generated text body.
The server outputs the formatted message to the communication channel via a network interface, causing the communication platform or backend to deliver the message to all subscribed terminals.

### Step 10:

The terminal receives and displays the character-style message.
The terminal takes, as input, a message event from the communication channel that includes the generated text and display metadata, parses the event, and inserts the text into a message list maintained in local memory.
The terminal executes rendering operations on a display device, such as creating visual components for the message bubble, character avatar, and timestamp, and outputs a graphical representation of the character-style message to the user.

### Step 11:

The user inputs a business report text at the terminal.
The terminal displays an input area for business reports and prompts the user to describe actual work content.
The user enters a business report such as “Completed code review for feature X, fixed bug number 234, and attended the sprint planning meeting.”
The terminal takes, as input, the typed business report text, the selected character identifier, and the user identifier, constructs a structured business report request, and outputs this request to the server through the communication network.

### Step 12:

The server generates report instruction information from the business report text and the template information.
The server takes, as input, the business report text, the character identifier, and the user identifier, retrieves the corresponding template information from storage, and identifies key entities such as task names and identifiers within the report text using pattern matching or tokenization.
The server embeds constraints in the instruction information to preserve these key entities, and combines the template information and the business report text into a message sequence that instructs the generative AI model to rewrite the report in the character's style while keeping factual content unchanged.
The server outputs the resulting report instruction information as a structured message sequence to the model-interface module.

### Step 13:

The server requests generation of a character-impersonated business report from the generative AI model.
The server takes, as input, the report instruction information, performs tokenization and sets model parameters adapted to report length and complexity, and creates a model request for the generative AI model.
The server outputs this request to the model-execution service, which processes the sequence through the neural network to generate a rewritten business report text that reflects the selected character's style while preserving key entities.

### Step 14:

The server validates and post-processes the character-impersonated business report text.
The server takes, as input, the generated business report text, compares it against the original business report text to confirm the presence of predetermined identifiers and task labels, and flags discrepancies if required identifiers are missing.
The server then performs the same length limitation, prohibited word determination, and content formatting as in the earlier post-processing step, tailoring formatting to reporting style (for example, bullet list or numbered list).
The server outputs a validated and formatted business report text along with metadata such as channel identifier and report type.

### Step 15:

The server redistributes the character-impersonated business report to the communication channel.
The server takes, as input, the validated and formatted business report text and routing metadata, selects an appropriate report channel (for example, a daily report channel) based on configuration rules, and constructs a message payload that includes the character persona as the sender.
The server outputs this payload to the communication channel, causing the report to be delivered to all relevant terminals in the group.

### Step 16:

The terminal displays the character-impersonated business report to users.
The terminal takes, as input, a report message event from the communication channel, parses the payload to extract text and presentation metadata, and appends the report to a report view or timeline maintained in memory.
The terminal executes display operations to render the report with the character's avatar or label and, where appropriate, provides controls for users to respond or react, and outputs the visual representation of the character-impersonated report to the display device.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialogue systems that utilize generative AI models typically accept user text, forward the text as a simple prompt sentence to a generative model, and then return the generated text to a client terminal without substantial intermediate processing. Such architectures impose several technical limitations on the underlying computer technology.

First, the processing pipeline in existing systems is not structured to systematically combine emotion recognition, role/persona selection, and scenario control at the server side. The server often treats the user input as opaque text and does not transform it into structured control information (for example, explicit emotion labels, role attributes, dialogue purposes). As a result, the server cannot reliably construct prompt sentences that encode fine-grained generation constraints. This leads to unstable generation behavior, increased variability in responses, and a need for repeated calls to the generative AI model, thereby increasing computation load, network traffic, and latency.

Second, conventional systems do not tightly integrate emotion analysis with prompt construction logic. Emotion analysis, if present, is frequently implemented only as a passive tagging mechanism at the client or application layer, and is not used as a primary control signal when composing prompts sent to the generative AI model. Consequently, the generative AI model cannot consistently adapt its output to a user's emotional state, which forces the client side to re-request alternative responses or perform additional post-processing, degrading overall system responsiveness and resource efficiency.

Third, known systems do not provide a unified server-centric mechanism to generate both user-centric responses and group-oriented random call-out messages using coordinated prompt design. Group activation messages in shared communication environments are often pre-scripted or generated using independent components, which are not synchronized with the same role/persona configuration and emotion control used for one-to-one dialogue. This fragmented design increases software complexity and often requires multiple separate services or processes, resulting in redundant resource usage and increased failure modes.

Fourth, in many deployments, generative AI models are invoked with large, unstructured prompts containing full conversation history. This increases the amount of data processed per call, leads to inefficient token usage, and lengthens processing time at the generative AI model. Without a structured prompt construction stage at the server, the system cannot effectively compress, normalize, and abstract the control information (for example, by using compact role attributes, scenario templates, and emotion labels), and therefore cannot optimize the computational load of the generative AI model.

Therefore, there is a need for a server-centric system and method that explicitly structures the processing pipeline into (i) input normalization, (ii) emotion analysis, (iii) role and scenario selection, (iv) controlled prompt sentence construction, (v) generative AI model invocation, and (vi) output post-processing, and that reuses the same mechanism both for individual dialogue responses and for group call-out messages. Such a system should improve computational efficiency, reduce latency and token consumption, stabilize the behavior of the generative AI model, and provide a more controllable and predictable generation process, thereby improving the overall performance and technical quality of AI-assisted communication systems.

The specific processing by the specific processing unit 290 of the data processing device 12 in Application Example 2 is realized by the following means.

The present invention provides a server comprising a processor configured to acquire natural language input information from a user via a communication interface, to preprocess and normalize the input information as text information, to execute emotion analysis processing on the text information to generate emotion information representing an emotional state of the user, to extract, on the basis of the text information and the emotion information, role information, speaker attribute information, and dialogue purpose information, to select dialogue scenario information and speaker persona information associated with the role information, the speaker attribute information, and the dialogue purpose information, to construct a prompt sentence for use in a generative process on the basis of at least the role information, the speaker attribute information, the dialogue purpose information, the emotion information, and the dialogue scenario information, to input the prompt sentence to a generative AI model and cause the generative AI model to generate response information corresponding to the role information and the emotion information, to perform post-processing on the response information in accordance with at least one of an expression length, a writing style, an expression format, and an output medium type to generate dialogue output information, to transmit the dialogue output information to a terminal device for display or audio output, and, in an information sharing environment connected via a communication medium, to construct, at a random timing or in accordance with a predetermined condition, a group-call prompt sentence to be input to the generative AI model, to cause the generative AI model to generate an information provision message for a group call on the basis of the group-call prompt sentence, and to transmit the information provision message to the information sharing environment. This enables the server to convert unstructured user input into structured control signals comprising emotion information, role information, dialogue purpose information, and scenario information, to compose compact and constrained prompt sentences that efficiently guide the generative AI model, to generate stable and context-appropriate responses and group messages with reduced computational overhead and latency, and to improve the technical performance, controllability, and resource efficiency of a computer-implemented dialogue system employing a generative AI model.

The term “processor” refers to a hardware or virtual computation unit, such as a central processing unit or a processing core, that executes machine-readable instructions to perform data processing, control logic, and communication operations.

The term “natural language input information” refers to information expressed in a human language, such as text or speech content, that is provided by a user and is suitable for linguistic analysis and interpretation by a computing device.

The term “preprocess” refers to performing one or more operations on raw input data, including at least normalization of character encoding, removal or replacement of control characters, adjustment of whitespace, and optional language detection, to convert the data into a standardized text format suitable for subsequent processing.

The term “text information” refers to information represented as a sequence of characters in a structured encoding format, such as a character string, that is derived from user input and is used as an input to analysis or generation processes.

The term “emotion analysis processing” refers to a computational procedure that analyzes text information to determine one or more emotional characteristics, such as sentiment polarity or specific emotion categories, using a statistical model, rule-based model, or machine learning model.

The term “emotion information” refers to data representing an estimated emotional state of a user, including at least one of an emotion label, an emotional intensity value, and an emotion score distribution, derived from emotion analysis processing on text information.

The term “role information” refers to attribute data specifying a conversational role to be imitated by a dialogue system, such as a persona type, social role, or character profile, that constrains or guides the style and content of generated responses.

The term “speaker attribute information” refers to attribute data describing characteristics of a virtual speaker, including at least one of linguistic style, dialect, age group, gender style, politeness level, or cultural background, that affects the expression form of generated text.

The term “dialogue purpose information” refers to attribute data indicating an intended communicative function of a dialogue turn, such as explanation, recommendation, encouragement, reporting, question, or greeting, which is used to control the content and structure of generated responses.

The term “dialogue scenario information” refers to data defining a context template or pattern for a dialogue, including constraints on turn structure, topic framing, and response format, that is associated with at least one of role information, speaker attribute information, and dialogue purpose information.

The term “speaker persona information” refers to structured data describing behavioral guidelines, typical phrases, and stylistic rules for a virtual speaker, used to maintain a consistent identity and manner of speaking across multiple generated responses.

The term “prompt sentence” refers to a textual instruction or a set of textual instructions provided as an input to a generative AI model, including at least one of system-level guidance and user-level content, that specifies how the model should generate a response.

The term “generative AI model” refers to a machine learning model, such as a neural network-based language model, that is capable of generating new text sequences or other data in response to an input prompt sentence, based on patterns learned from training data.

The term “generative process” refers to a computation performed by a generative AI model in which an output sequence is generated from an input prompt sentence according to model parameters and internal learned representations.

The term “response information” refers to data generated by a generative AI model in response to a prompt sentence, including at least textual content intended to be provided as a reply in a dialogue or as a message in a communication environment.

The term “post-processing” refers to a set of operations applied to response information after generation, including at least one of truncation, reformatting, style adjustment, addition or removal of fixed phrases, and conversion for compatibility with an output medium.

The term “dialogue output information” refers to response information that has been subjected to post-processing and is in a form suitable for presentation to a user via a terminal device, such as formatted text for display or text prepared for speech synthesis.

The term “terminal device” refers to an end-user equipment, such as a portable information processing device, wearable display device, or stationary computing device, that communicates with a server and performs at least one of input acquisition and output presentation for a user.

The term “communication medium” refers to a physical or logical communication channel, such as a wired or wireless network, that enables data transmission between a server, one or more terminal devices, and optionally other systems.

The term “information sharing environment” refers to a logical or physical environment, such as a group communication platform, messaging space, or shared workspace, in which messages or content are distributed to and accessed by multiple users or devices.

The term “group-call prompt sentence” refers to a prompt sentence constructed for the purpose of causing a generative AI model to generate a message directed to multiple recipients in an information sharing environment, such as a call-out, question, or information notice.

The term “information provision message” refers to a message generated by a generative AI model on the basis of a group-call prompt sentence, the message including content that provides information, raises a topic, or invites responses from members of an information sharing environment.

The term “regional language variant” refers to a variety of a natural language that is characteristic of a particular geographic region or community, including at least dialectal vocabulary, pronunciation patterns represented in text, and region-specific expressions.

The term “fictitious human figure” refers to a non-real person or character defined for narrative or interaction purposes, including a character from a story, a symbolic persona, or an imagined role used for dialogue generation.

The term “virtual role” refers to a role that is not tied to an actual human individual but is conceptually defined for a dialogue system, such as a guide, advisor, mentor, or thematic character, and that can be imitated by a generative AI model in generated expressions.

In one embodiment, a server, a plurality of terminals, and an information sharing environment are interconnected via a communication medium such as a packet-switched data network. The server includes at least one hardware processor, a main memory, a non-volatile storage device, and a network interface. The server executes an operating system and an application program that implements the functions described below. The terminals include, for example, portable information processing devices, wearable display devices, and stationary computing devices, each having a display unit, an input unit, an audio input/output unit, a local processor, a memory, and a communication interface.

The server stores, in the storage device, a set of software modules including at least: an input normalization module, an emotion analysis module, a role and scenario selection module, a prompt construction module, a generative AI interface module, a post-processing module, and a communication control module. The server also stores model parameters of an emotion recognition model and configuration data for role information, speaker attribute information, and dialogue scenario information. The server further stores connection information, such as API keys and endpoint URLs, for an external or internal generative AI model.

The server uses commercially available hardware such as a general-purpose server computer based on a multi-core central processing unit, a main memory of several gigabytes or more, and a network interface compliant with standard communication protocols. The server uses a general-purpose operating system and a programming runtime environment such as a script language interpreter or a virtual machine. The server executes the above modules as software components organized as processes or threads.

The terminal executes an application program that presents a user interface for natural language input and for display or audio output of dialogue output information. The terminal uses an operating system-provided graphical framework to render text, buttons, and notifications on the display unit. The terminal uses an audio input/output framework to capture speech and to play synthesized audio. The terminal transmits user input information such as text strings or speech-derived text to the server via the communication medium and receives dialogue output information from the server.

The user operates the terminal to provide natural language input information in text or speech form. The user may, for example, type a sentence such as “It didn't go well at work today” or “Explain the main features of this product as a middle-aged man using Kansai dialect.” The terminal converts speech input to text using a speech recognition engine and transmits the text to the server as part of a structured data object such as a message body including user identification, session identification, and optional explicit role specification.

The server applies the input normalization module to the received natural language input information. The server converts the text to a standardized character encoding, normalizes whitespace, removes or replaces control characters, and optionally performs language identification using a statistical classifier. The server represents the normalized text in an internal data structure, for example as a sequence of Unicode code points stored in a character buffer. This normalization step reduces variation in the input data and simplifies subsequent analysis, thereby reducing processing errors and improving computational efficiency in downstream modules.

The server applies the emotion analysis module to the normalized text information. In one embodiment, the server uses a trained neural network model that includes an embedding layer, multiple bidirectional recurrent layers, and a fully connected layer with a softmax output. The server converts the text into a sequence of token identifiers using a tokenizer, retrieves corresponding embedding vectors, and feeds the sequence of vectors to the recurrent layers. The recurrent layers compute hidden state vectors based on learned weight matrices and nonlinear activation functions. The fully connected layer maps the final hidden state to a set of emotion scores corresponding to categories such as joy, sadness, anger, fear, and tiredness. The softmax function converts the scores into a probability distribution. The server interprets the probability distribution using predetermined thresholds to select an emotion label such as “feeling down” or “tired,” and stores both the label and the scores as emotion information.

The server trains the emotion analysis model in advance using supervised learning on a training dataset consisting of pairs of text examples and emotion labels. The server uses a loss function such as cross-entropy between predicted probabilities and ground-truth labels. The server updates the model parameters using an optimization algorithm such as stochastic gradient descent with an adaptive learning rate. The server may apply regularization methods such as dropout and L2 regularization to prevent overfitting. The server may also apply data augmentation methods such as synonym substitution and paraphrasing to increase the diversity of training data. By using these learning techniques, the server obtains an emotion analysis model that operates with higher classification accuracy and robustness compared to simple rule-based or manual methods.

The server applies the role and scenario selection module to the text information and the emotion information. The server uses a rule set and a mapping table stored in the storage device. The mapping table associates combinations of emotion labels, dialogue purpose information, and explicit user requests with role information and dialogue scenario information. The server extracts candidate dialogue purposes by pattern matching or by a lightweight classifier that analyzes verbs, objects, and interrogative forms in the text. For example, the server may determine that the purpose is “product explanation” when the text contains terms indicating goods or services and question patterns, or “encouragement” when the emotion label indicates negative feelings and the text contains complaint-like patterns.

The server selects role information and speaker attribute information based on the extracted dialogue purpose and the emotion information. For example, when the emotion label is “feeling down” and the dialogue purpose is “encouragement,” the server may select a role such as a friendly counselor or a humorous character. When the user explicitly requests a role in the text, such as “a middle-aged man using Kansai dialect” or “an otherworld wizard,” the server combines the explicit request with the emotion information and the dialogue purpose to select a final role. The server stores the selected role as attribute data that includes at least a label identifier, a set of stylistic rules, and persona description text.

The server prepares dialogue scenario information associated with the selected role and the dialogue purpose. The dialogue scenario information includes template segments, constraints on length, tone, and structure, and conditions regarding mandatory or prohibited content. For example, a scenario for product explanation may specify that the response should include at least one feature description and one benefit description, and that technical terms should be explained in plain language. A scenario for encouragement may specify that the response should acknowledge the user's feelings and provide at least one positive outlook statement.

The server applies the prompt construction module to the role information, the speaker attribute information, the dialogue purpose information, the emotion information, and the dialogue scenario information. The server constructs a prompt sentence comprising at least a system-level instruction and a user-level instruction. The server may, for example, compose a system-level instruction as follows:
“You are a friendly middle-aged man from a specific region. You always speak in that regional dialect and respond in a cheerful and supportive way.”

The server may compose a user-level instruction as follows:
“The user text is: ‘It didn't go well at work today’. The user is feeling down. As a middle-aged man using the regional dialect, please generate a short, encouraging reply that acknowledges the user's feelings and tells the user that tomorrow will be better.”

The server concatenates these instruction texts into a prompt sentence in the format required by the generative AI model. The server stores the prompt sentence in a structured data object that also includes generation parameters such as maximum length, sampling temperature, and top-p value. The server thereby encapsulates complex control information into a compact textual instruction that efficiently guides the generative AI model.

The server applies the generative AI interface module to invoke a generative AI model. In one embodiment, the server uses a large-scale autoregressive language model having multiple transformer layers. Each layer includes self-attention mechanisms that compute attention weights between tokens and feedforward networks with nonlinear activation. The model has been pre-trained on large corpora of text and fine-tuned on dialogue data. The server sends the prompt sentence as an input sequence of token identifiers to the generative AI model. The model computes a sequence of hidden states using learned weight matrices, bias vectors, and layer normalization operations. At each generation step, the model computes a probability distribution over the vocabulary, and the server selects the next token according to sampling rules based on the generation parameters. The model continues this process until an end-of-sequence condition is satisfied or the maximum length is reached.

The server may operate the generative AI model as an external service via an application programming interface or as an internal model executing on a dedicated accelerator such as a graphics processing unit. When the server uses an external service, the generative AI interface module formats the prompt sentence and generation parameters into a request payload, sends the request via the network interface, and receives the generated response information. When the server uses an internal model, the generative AI interface module provides the prompt sentence as input to the model execution engine running in the server process. In both cases, the server receives response information consisting of generated text and metadata such as token counts and generation status.

The server applies the post-processing module to the response information. The server may truncate or segment the text if the length exceeds the scenario constraints, adjust punctuation, and apply pattern-based filters to remove undesired expressions according to safety rules. The server may also add prefix or suffix phrases that identify the character, such as a name tag or a greeting, depending on the selected role. The server formats the resulting text into dialogue output information suitable for the terminal's display or audio synthesis. The server optionally tags the dialogue output information with metadata indicating the emotion label, the role, and the dialogue purpose so that the terminal can adapt the user interface presentation.

The server uses the communication control module to transmit the dialogue output information to the terminal. The terminal receives the dialogue output information via the communication interface, parses the structured data, and renders the text on the display. The terminal may, in addition, feed the text to a text-to-speech engine to generate audio output. The terminal thereby presents the character-style response to the user. The user may use the displayed or spoken content as a basis for real-world conversation, for example with a customer in a physical store.

The server also implements group communication functions based on the same architecture.

The server stores configuration information for an information sharing environment such as a group messaging space. The server periodically or conditionally constructs a group-call prompt sentence using the role information and dialogue scenario information configured for group activation. For example, the server may construct a prompt sentence such as:
“You are a cheerful mascot speaking a regional dialect for a business chat group. Generate a short, playful question in the regional dialect asking everyone about today's lunch.”

The server applies the generative AI interface module to obtain an information provision message based on this group-call prompt sentence and transmits the information provision message to the information sharing environment. Because the server reuses the same prompt construction and generative AI interface modules for both individual dialogue and group messages, the server maintains consistency in persona behavior and style across different communication channels, and avoids duplicating logic in multiple components.

By structuring the processing pipeline explicitly into normalization, emotion analysis, role and scenario selection, prompt construction, generative model invocation, and post-processing, the server improves technical aspects of the system. The server reduces the amount of context that must be sent to the generative AI model by abstracting the user input into compact control information such as emotion labels, role identifiers, and scenario identifiers. This reduction in input size decreases token consumption in the generative AI model, lowers network bandwidth usage when using external model services, and shortens processing time. The server stabilizes the quality of generated responses because the prompt sentences consistently encode desired behavior, thereby reducing the need for repeated generation requests and mitigating variance in model output.

The server also improves accuracy and appropriateness of responses by combining emotion information with role and scenario templates before constructing prompt sentences. The server does not simply pass raw user text to the generative AI model; instead, the server transforms the text into structured features that act as explicit control signals. This transformation reflects a non-conventional sequence of operations compared to ordinary client-side or application-level handling, and directly optimizes the internal behavior of the generative AI model. The server thereby achieves a technical effect of improved response relevancy and style consistency without increasing computational demand.

The server further provides a technical improvement in resource management. The server can adjust generation parameters based on scenario data, such as lowering the sampling temperature for business reporting tasks to reduce randomness and shorten the required text length, or raising it for casual conversation to increase variety. By controlling these parameters centrally, the server optimizes the use of computational resources of the generative AI model. This optimization reduces processing time and model load, allowing higher throughput on the same hardware.

In another embodiment, the server employs alternative machine learning architectures for emotion analysis, such as a transformer-based classifier using self-attention layers. The server trains the classifier using loss functions appropriate for multi-label classification when multiple emotion categories must be detected simultaneously. The server may also use a hierarchical classifier that first determines a coarse polarity such as positive or negative and then refines it into more detailed categories. These variations demonstrate that the system is not limited to a single algorithm but can use different model structures, as long as the server produces emotion information used in prompt construction.

In another embodiment, the server employs rule-based selection of role information and dialogue scenario information without machine learning in that module. For example, the server may use a decision tree encoded as a set of if-then rules that compare emotion labels and dialogue purposes with predefined patterns. This embodiment maintains the same overall data flow and technical effects, while simplifying the implementation of the role and scenario selection module.

In another embodiment, the server executes the generative AI model fully on-premises using a dedicated accelerator such as a graphics processing unit or a specialized tensor processing unit. The server partitions the generative AI model across multiple accelerators to parallelize matrix multiplications and attention computations. The server applies mixed-precision arithmetic during inference to reduce memory usage and computation time while maintaining acceptable quality. This embodiment enhances processing throughput and latency characteristics at the hardware level, and further demonstrates that the system is directed to technical improvements in computer execution of generative modeling.

In still another embodiment, the terminal is a wearable display device such as smart glasses. The terminal overlays the dialogue output information on a transparent display in the user's field of view. The user can thereby read a character-style script while interacting with another person in the physical environment. The server's structured processing chain contributes to timely and concise generation of such scripts so that the user receives relevant assistance with minimal delay, improving the practical usability of the system in real-time communication scenarios.

By implementing the described hardware and software configuration, and by employing the specific sequence of data transformations on structured internal data objects, the server, the terminal, and the user cooperatively achieve a dialogue system that not only automates text generation but also improves the underlying computer technology in terms of processing efficiency, control over generative behavior, and resource utilization. The system thus goes beyond mere automation of human tasks and provides concrete technical effects such as reduced latency, decreased token and bandwidth usage, improved accuracy and consistency of generated responses, and enhanced management of computational load in generative AI processing.

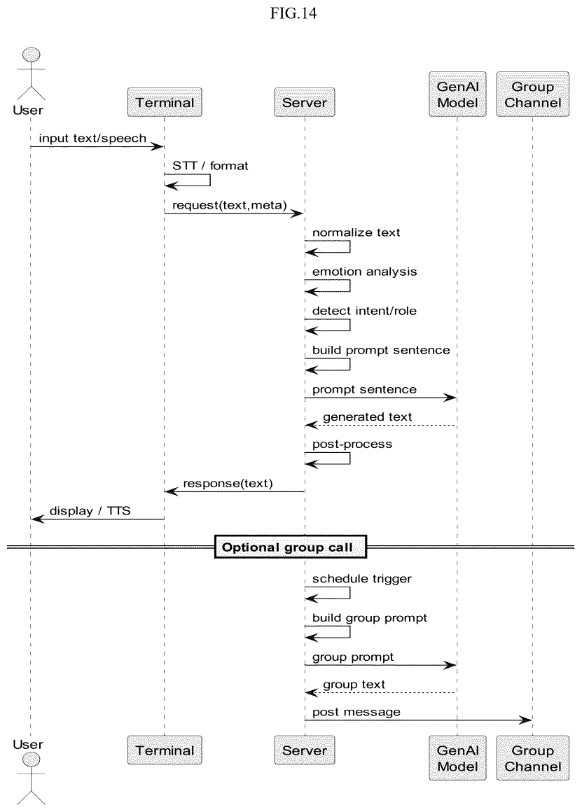

The following describes the processing flow using FIG. 14.

### Step 1:

User operates the terminal to provide natural language input.
User types a text such as “It didn't go well at work today” or speaks a sentence such as “Explain the features of this product as a middle-aged man using Kansai dialect” into the microphone of the terminal. The input is raw human language data. User thereby supplies application-level intent and optional role hints as part of the text content.

### Step 2:

Terminal acquires and formats the input for transmission.
Terminal receives keyboard events or audio signals from the input unit as input, and, when audio is used, terminal applies a speech recognition engine to convert the audio waveform into a character string. Terminal then creates a structured message object including at least a user identifier, a session identifier, and a text field containing the recognized or typed sentence. Terminal may also add explicit role selection flags if the user configured them in the UI. As a result, terminal outputs a normalized request payload ready to be sent to the server.

### Step 3:

Terminal transmits the request payload to the server.
Terminal uses the communication interface to send the request payload as a network message over a communication medium. The input to this step is the structured message object created in Step 2. Terminal performs serialization of the object into a transport format and attaches protocol headers. The output of this step is a network-level data stream containing the user's text and related metadata, delivered to the server.

### Step 4:

Server receives the request and performs input normalization.
Server accepts the incoming network message as input and parses the transport format to reconstruct the structured message object. Server extracts the text field and converts it into a standard character encoding. Server removes invalid characters, normalizes whitespace sequences, and optionally performs language detection using a statistical classifier. Based on these operations, server transforms raw user text into normalized text information stored in an internal buffer. The output of this step is normalized text plus associated metadata such as user and session identifiers.

### Step 5:

Server executes emotion analysis on the normalized text.
Server takes the normalized text as input and converts it into a sequence of tokens using a tokenizer. Server maps each token to a numerical vector using an embedding table and feeds the sequence of vectors into an emotion recognition model, such as a recurrent neural network or a transformer-based classifier. Inside the model, server applies matrix multiplications, nonlinear activation functions, and attention or recurrence operations to compute hidden state vectors, and then applies a final linear layer and a softmax function to obtain a probability distribution over emotion categories. Server interprets this distribution using predefined thresholds and selects a dominant emotion label, while also retaining the full vector of emotion scores. The output of this step is emotion information consisting of at least one label (for example, “feeling down”) and a set of numerical scores derived from the text.

### Step 6:

Server extracts dialogue purpose and candidate role information.
Server uses the normalized text and the emotion information as input and runs a lightweight natural language analysis module. Server may apply pattern matching or a small classifier to detect verbs, objects, question forms, and explicit role phrases such as “as a middle-aged man” or “as a wizard.” Server maps these detected elements to dialogue purpose information such as “product explanation,” “encouragement,” or “business report.” Server also identifies any explicit role phrases and converts them into internal role identifiers. The output of this step is a set of attributes, including dialogue purpose information and candidate role information extracted from the user text.

### Step 7:

Server selects final role and dialogue scenario information.
Server takes as input the dialogue purpose information, the candidate role information, and the emotion information produced in the previous steps. Server consults a configuration data structure, such as a table that maps combinations of purpose and emotion to default roles and scenario templates. Server compares the candidate role with the default role, and applies resolution rules, such as preferring explicit user requests but adjusting for highly negative emotions when necessary. Server selects a final role identifier and retrieves associated scenario and persona records from storage. These records include template text segments, style parameters, and structural constraints. The output of this step is a final role information object and dialogue scenario information that jointly define how the system should respond.

### Step 8:

Server constructs a prompt sentence for the generative AI model.
Server takes as input the normalized text, the emotion information, the final role information, and the dialogue scenario information. Server composes a system-level instruction string that describes the persona and general behavior, and a user-level instruction string that embeds the user's original text and indicates the emotion and task. Server may fill placeholders in scenario templates with concrete values, such as emotion labels and length constraints. Server then concatenates or arranges these strings into a structured prompt sentence in the format required by the generative AI model. The output of this step is a complete prompt sentence together with generation parameters such as maximum token count and sampling temperature.

### Step 9:

Server invokes the generative AI model with the constructed prompt sentence.
Server takes the prompt sentence and generation parameters as input and converts the text into token identifiers using the tokenizer of the generative AI model. Server sends these token identifiers and parameters either to an external model service over the network or to a local inference engine running on accelerator hardware. Inside the model, multiple transformer layers perform self-attention, linear projection, and non-linear activation operations to iteratively compute probability distributions over possible next tokens. Server instructs the model to repeatedly sample or choose tokens based on these distributions and the specified parameters until a termination condition is met. The output of this step is response information, which consists of a sequence of generated tokens subsequently decoded into a text string.

### Step 10:

Server performs post-processing on the generated response information.
Server receives the generated text as input and checks it against the dialogue scenario constraints, such as maximum length, required acknowledgment of emotion, and required politeness level. Server may truncate the text, split overly long responses into segments, or discard trailing incomplete sentences. Server also may apply pattern-based filters to correct or remove unsuitable phrases. Server optionally appends or prepends fixed expressions associated with the selected role, such as a character-specific greeting. The output of this step is dialogue output information, which is the cleaned and formatted response text ready for presentation.

### Step 11:

Server generates and attaches metadata for output.
Server takes the dialogue output information and the internal control data (emotion information, role information, dialogue purpose information) as input. Server creates a response object that includes the text plus metadata fields such as the emotion label, the role identifier, and scenario type indicators. Server may also include technical metadata such as generation time and token counts. Server thereby transforms separate control signals and generated text into a single structured response object. The output of this step is the structured response object suitable for transmission to the terminal.

### Step 12:

Server transmits the dialogue output information to the terminal.
Server uses the communication control module to take the structured response object as input and serialize it into a network message. Server applies appropriate encoding and attaches protocol headers, then sends the message over the communication medium to the terminal's network address. The output of this step is a network-level data stream carrying the dialogue output information and metadata to the terminal.

### Step 13:

Terminal receives and renders the dialogue output information.
Terminal accepts the incoming network message as input and deserializes it to reconstruct the structured response object. Terminal extracts the response text and optional metadata. Terminal then updates the user interface by displaying the text in a conversation view or overlay and may use emotion or role metadata to adjust colors, icons, or layout. The output of this step is the rendered visual representation on the display or, optionally, audio playback when terminal passes the text to a text-to-speech engine and plays resulting audio through the speaker.

### Step 14:

User consumes the response and optionally continues the interaction.
User reads the displayed text or listens to the audio output as input and interprets the character-style response in the current context, such as a store interaction or group communication. Based on this information, user may decide to take real-world action or to provide further input to the system, thereby generating a new natural language input that becomes the input of a new cycle starting from Step 1.
Step 15:
Server optionally generates a group-call message for an information sharing environment.
Server uses scheduling information and group configuration as input and determines that a random or condition-based call-out should be made to a group. Server selects role information and scenario information suitable for group activation and constructs a group-call prompt sentence using similar operations as in Step 8. Server invokes the generative AI model as in Step 9, receives a generated group message, and applies post-processing as in Step 10. The output of this step is an information provision message that is then sent, via the communication control module, to the information sharing environment, where it becomes visible to multiple users.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

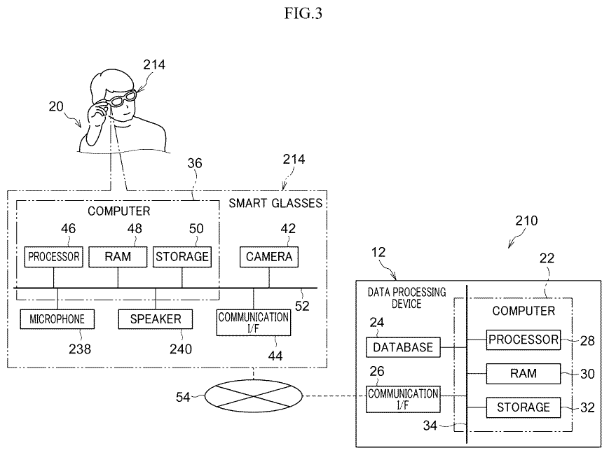

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

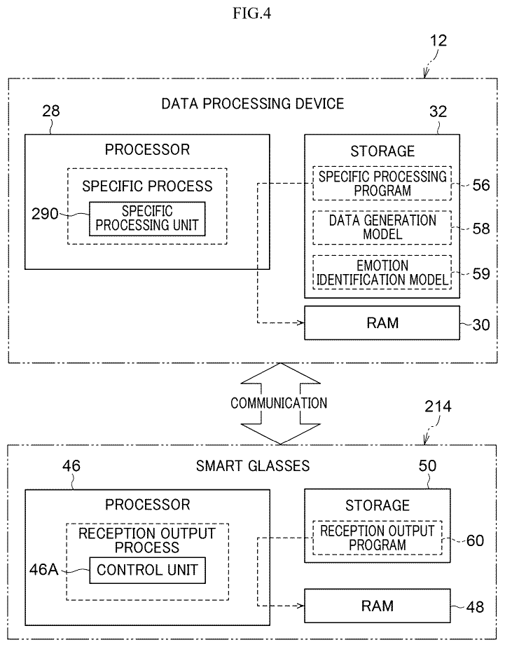

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

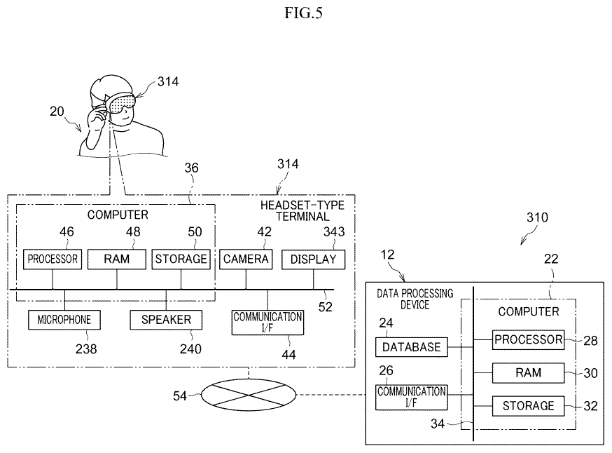

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

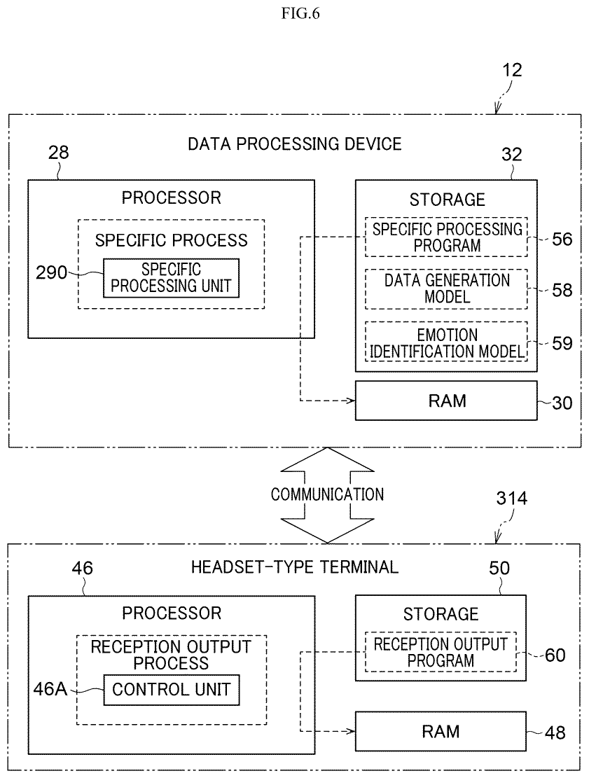

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

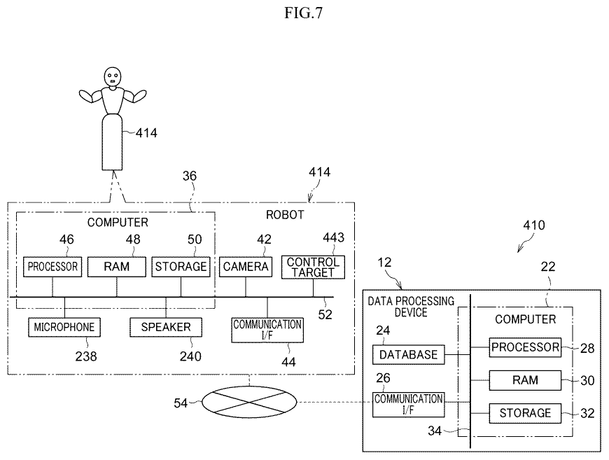

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

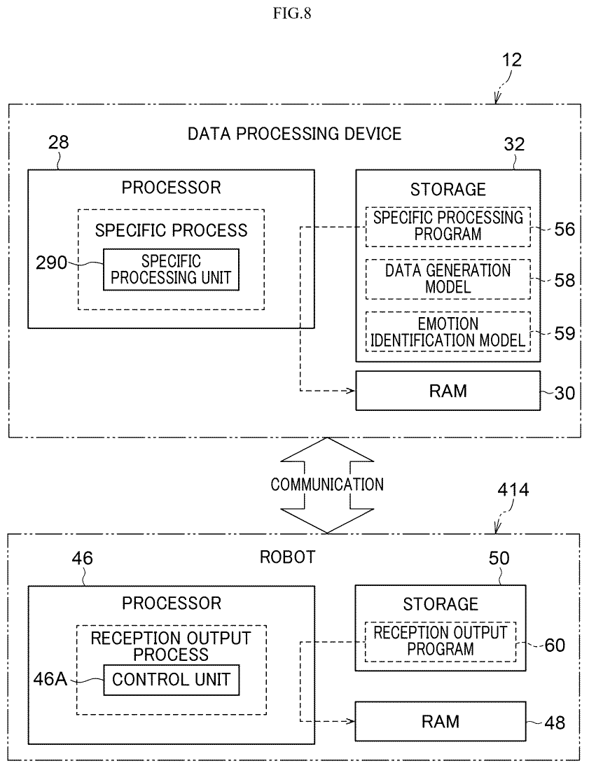

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

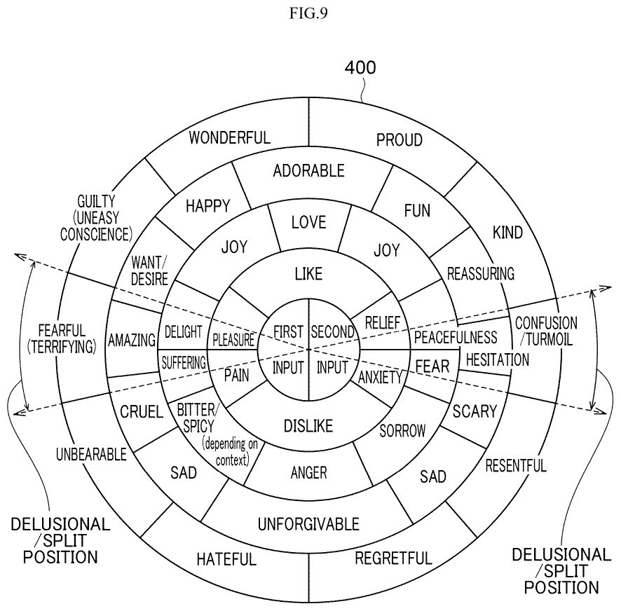

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

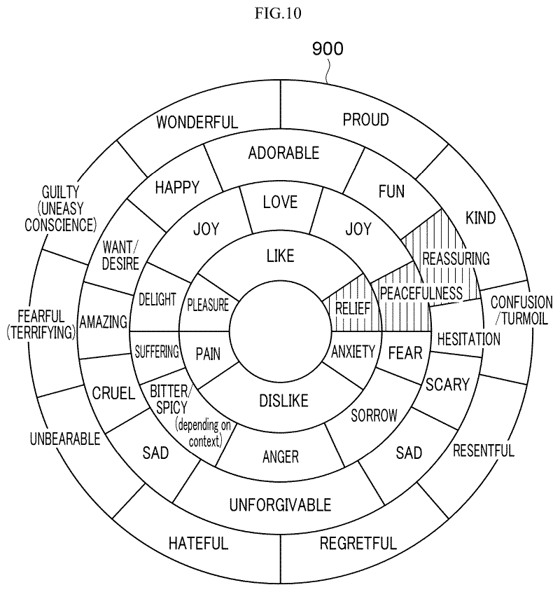

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
read, from a storage region, a generative AI model as a generation-type information processing model, initialize the generative AI model, and input to the generative AI model a prompt sentence including role information and language expression conditions designated by a user, thereby setting a dialogue style according to a role,
acquire group identification information for identifying a communication group on a communication network, register an information processing function as a member of the communication group, determine a time for performing information provision or a call for attention on the basis of time information and random number generation processing, and
input to the generative AI model a prompt sentence based on a determination result and the role information to generate information to be transmitted to the communication group, acquire character information of the user from a terminal device, store the character information in a storage device, and input to the generative AI model a prompt sentence based on the character information and the role information to generate response information in which the role is played, and transmit the response information to the terminal device via the communication network,
acquire a prompt sentence including, for each user or for each communication group, at least one of role information, writing style conditions, utterance length constraints, and topic types, store the prompt sentence as a base setting for the generative AI model, and automatically add the base setting in subsequent information generation to call the generative AI model, thereby realizing dialogue in which role expression is continuously maintained,
acquire report information including at least one of task content information and behavior record information, combine the report information with the role information as a prompt sentence, input the prompt sentence to the generative AI model to generate transformed report information in which factual content is maintained and an expression according to the role is applied, and distribute the transformed report information to the communication group, and
accumulate response history information of users in the communication group, extract, on the basis of the response history information, at least one of topic candidates and preference tendencies, and input to the generative AI model a prompt sentence including an extraction result to generate information for performing information provision or a call for attention according to characteristics of the communication group.

### Supplementary 2

The system according to supplementary 1,
wherein the processor is configured to
input to the generative AI model a prompt sentence instructing imitation of a regional language variant or a speech characteristic, and reproduce the regional language variant or the speech characteristic in information or response information to be distributed to the communication group.

### Supplementary 3

The system according to supplementary 1,
wherein the processor is configured to
input to the generative AI model a prompt sentence instructing imitation of a fictional personality or an imagined role, and reproduce a behavior style of the fictional personality or the imagined role in information or response information to be distributed to the communication group.

### Application Example 1

### Supplementary 1

A system comprising a processor, a communication interface, and an information terminal,
wherein the processor is configured to
receive audio data obtained by the user performing voice input via the information terminal, and convert the audio data into character data by using a speech recognition function,
transmit the character data to an external information processing apparatus having a natural language processing function, and obtain analysis result data including intention information and attribute information from the external information processing apparatus,
determine, on the basis of the analysis result data and conversation history data, role information including a type of response role, speaker attribute, speaking style attribute, and emotion attribute, and generate a prompt sentence including the role information and the character data,
input the prompt sentence to a generative AI model and cause the generative AI model to generate response text that impersonates the role in accordance with the role information,
perform post-processing on the response text, the post-processing including detection of inappropriate expressions, length adjustment, and insertion of additional information, and
transmit post-processed response text to the information terminal via the communication interface,
wherein the information terminal is configured to display the response text on a display by a display function, convert the response text into audio data by using a speech synthesis function, and output the audio data via an output device,
and wherein the processor is further configured to use the generative AI model to generate a call message, transmit the call message to the information terminal via the communication interface at a random timing or with a random probability in a communication network, and promote initiation of a dialogue using the call message,
and wherein the processor is further configured to analyze character input or voice input from the user, estimate an emotional state by emotion recognition processing, generate a second prompt sentence in which the role information is changed in accordance with the emotional state, and input the second prompt sentence to the generative AI model to cause the generative AI model to generate response text corresponding to the emotional state.

### Supplementary 2

The system according to supplementary 1,
wherein the processor is configured to generate the prompt sentence by specifying, as the speaking style attribute included in the role information, a regional variety, dialect, or lexical tendency, and input the prompt sentence to the generative AI model so that the response text is generated in the regional variety or the dialect.

### Supplementary 3

The system according to supplementary 1,
wherein the processor is configured to generate the prompt sentence by specifying, as the speaker attribute included in the role information, attribute information indicating a fictional person, a virtual personality, or a virtual entity, and input the prompt sentence to the generative AI model so that the response text is generated in an expression impersonating the fictional person, the virtual personality, or the virtual entity.

### Example 2

### Supplementary 1

A system comprising a processor,
wherein the processor is configured to
receive input information from a user terminal, the input information including character selection information and a prompt sentence, and generate generation instruction information by combining template information defining attributes of a character with the prompt sentence on the basis of the input information; and
generate a message sequence including the generation instruction information, transmit the message sequence to a generative AI model disposed externally or internally, and acquire generated text that imitates wording and tone of the character by text generation processing executed by the generative AI model; and
perform post-processing on the acquired generated text, the post-processing including at least one of length limitation, prohibited word determination, and content formatting, store the post-processed generated text in association with distribution destination information of a communication channel shared within a group, and transmit the post-processed generated text to the communication channel; and
receive text information including a business report text acquired through the communication channel, generate report instruction information by combining the text information with the template information defining the attributes of the character, transmit the report instruction information to the generative AI model so as to cause the generative AI model to generate a business report text in which the character is impersonated, and redistribute the generated business report text to the communication channel; and
transmit and receive user interface information to and from the user terminal, the user interface information relating to character selection, input of the prompt sentence, and input of the business report text, and control display and input operations on the user terminal.

### Supplementary 2

The system according to supplementary 1,
wherein the processor is configured to
include, in the generation instruction information or the report instruction information, language attribute information indicating features of a regional language or speaking style, and generate, by using the generative AI model, generated text that imitates the regional language or the speaking style.

### Supplementary 3

The system according to supplementary 1,
wherein the processor is configured to
include, in the generation instruction information or the report instruction information, attribute information indicating a fictitious person, an occupation image, or a role image, and generate, by using the generative AI model, generated text that imitates wording and tone of the fictitious person, the occupation image, or the role image.

### Application Example 2

### Supplementary 1

A system comprising a processor,
wherein the processor is configured to
acquire natural language input information from a user,
preprocess the input information and normalize the input information as text information,
execute emotion analysis processing using the text information, and generate emotion information representing an emotional state of the user,
extract, on the basis of the text information and the emotion information, role information requested by the user, speaker attribute information, and dialogue purpose information, and
select dialogue scenario information and speaker persona information associated with the role information, the speaker attribute information, and the dialogue purpose information,
construct a prompt sentence for use in a generative process, on the basis of the role information, the speaker attribute information, the dialogue purpose information, the emotion information, and the dialogue scenario information,
input the prompt sentence to an internal or external generative AI model and cause the generative AI model to generate response information corresponding to the role information and the emotion information,
perform post-processing on the generated response information in accordance with at least one of expression length, writing style, expression format, and output medium type, and generate dialogue output information,
transmit the dialogue output information to a terminal device and cause the terminal device to perform at least one of display output and audio output of the dialogue output information, and
in an information sharing environment connected via a communication medium, construct a group-call prompt sentence to be transmitted to the generative AI model at a random timing or in accordance with a predetermined condition, cause the generative AI model to generate an information provision message for the group call on the basis of the group-call prompt sentence, and transmit the information provision message to the information sharing environment.

### Supplementary 2

The system according to supplementary 1,
wherein the processor is configured to include, in the prompt sentence, as the role information, an attribute indicating a regional language variant and to cause the generative AI model to generate an expression that imitates the regional language variant.

### Supplementary 3

The system according to supplementary 1,
wherein the processor is configured to include, in the prompt sentence, as the role information, an attribute indicating a fictitious human figure or a virtual role and to cause the generative AI model to generate an expression that imitates the fictitious human figure or the virtual role.

What is claimed is:

1. A system comprising:
circuitry configured to:
acquire, via a packet-switched network, role designation data specifying a behavioral profile and language expression parameters for a generative information processing model,
generate, based on the role designation data and a stored base configuration, a composite instruction sequence that encodes the behavioral profile and the language expression parameters as conditioning inputs for the generative information processing model,
register an automated information processing function as a participant in a communication group identified by group identification data on the packet-switched network,
determine, based on time data and a pseudo-random value, a transmission timing for the communication group, and transmit to the generative information processing model an instruction sequence incorporating the transmission timing determination and the role designation data to generate an output data sequence for delivery to the communication group,
acquire text data from a terminal device, combine the text data with the composite instruction sequence, transmit the combined data to the generative information processing model, and obtain response data reflecting the behavioral profile, and
transmit the response data as a data packet via the packet-switched network to the terminal device.

2. The system according to claim 1, wherein the circuitry is configured to store the composite instruction sequence as a persistent base setting associated with the communication group, and automatically prepend the persistent base setting to subsequent instruction sequences transmitted to the generative information processing model.

3. The system according to claim 2, wherein the persistent base setting includes at least one of writing style parameters, output length constraints, and topic category identifiers.

4. The system according to claim 1, wherein the circuitry is configured to acquire structured report data including at least one of task content records and activity log records from the terminal device, combine the structured report data with the role designation data to generate a report instruction sequence, transmit the report instruction sequence to the generative information processing model to obtain transformed report data in which factual content is preserved and expression conforms to the behavioral profile, and distribute the transformed report data to the communication group.

5. The system according to claim 4, wherein the circuitry is configured to verify preservation of factual content by comparing identifier tokens and status values between the structured report data and the transformed report data prior to distribution.

6. The system according to claim 1, wherein the circuitry is configured to accumulate response history records from participants in the communication group, extract from the response history records at least one of topic candidate data and preference tendency data, and incorporate the extracted data into subsequent instruction sequences transmitted to the generative information processing model.

7. The system according to claim 6, wherein extracting the topic candidate data comprises computing feature vectors for the response history records using an embedding model and clustering the feature vectors based on similarity in a feature space.

8. The system according to claim 1, wherein the circuitry is configured to analyze the text data from the terminal device using an emotion estimation model to generate emotion state data, and modify the role designation data based on the emotion state data to generate an updated composite instruction sequence, and transmit the updated composite instruction sequence to the generative information processing model to obtain emotion-adapted response data.

9. The system according to claim 8, wherein the emotion estimation model is a neural network classifier trained to output a probability distribution over emotion categories using a cross-entropy loss function.

10. The system according to claim 8, wherein the emotion state data maps to coordinates in an emotion feature space defined by at least a valence dimension and an arousal dimension.

11. The system according to claim 1, wherein the role designation data includes a language variant attribute specifying a regional dialect, and the generative information processing model generates the output data sequence and the response data in the regional dialect.

12. The system according to claim 1, wherein the role designation data includes a fictional entity attribute specifying a fictional character persona, and the generative information processing model generates the output data sequence and the response data reflecting behavioral characteristics of the fictional character persona.

13. The system according to claim 1, wherein the circuitry is configured to perform post-processing on the response data, the post-processing including at least one of prohibited expression detection using a pattern matching data structure, output length adjustment based on a predetermined token limit, and insertion of supplemental data retrieved from a storage device.

14. The system according to claim 1, wherein the circuitry is configured to receive audio data from the terminal device, convert the audio data into text data using a speech recognition module, transmit the text data to an external natural language processing apparatus to obtain analysis result data including intention information and attribute information, and use the analysis result data to determine the role designation data.

15. The system according to claim 14, wherein the circuitry is configured to transmit the response data to the terminal device and cause the terminal device to convert the response data into synthesized audio using a speech synthesis module and output the synthesized audio via an output transducer.

16. The system according to claim 1, wherein the circuitry is configured to generate a call message by transmitting to the generative information processing model an instruction sequence conditioned on the role designation data, and transmit the call message to the terminal device at a timing determined by comparing a pseudo-random value against a probability threshold.

17. The system according to claim 1, wherein the generative information processing model comprises a transformer architecture including an embedding layer, a plurality of self-attention layers, and an output projection layer, and wherein model parameters have been trained by minimizing a cross-entropy loss between predicted token distributions and target tokens.

18. A system comprising:
circuitry configured to:
acquire, via a packet-switched network, role designation data specifying a behavioral profile for a generative information processing model,
generate a composite instruction sequence encoding the behavioral profile as conditioning inputs, and store the composite instruction sequence as a persistent base setting for subsequent interactions,
register an automated information processing function as a participant in a communication group on the packet-switched network,
determine a transmission timing based on time data and a pseudo-random value, and generate an output data sequence for the communication group using the generative information processing model conditioned on the role designation data,
acquire text data from a terminal device, analyze the text data using an emotion estimation model to generate emotion state data, modify the composite instruction sequence based on the emotion state data, and obtain emotion-adapted response data from the generative information processing model,
acquire structured report data from the terminal device, combine the structured report data with the role designation data, and obtain transformed report data from the generative information processing model in which factual content is preserved,
accumulate response history records from participants in the communication group and extract topic candidate data for incorporation into subsequent instruction sequences, and
transmit the output data sequence, the response data, and the transformed report data as data packets to the communication group via the packet-switched network.

19. The system according to claim 18, wherein the circuitry is configured to perform post-processing on the response data and the transformed report data, the post-processing including prohibited expression detection, output length adjustment, and content formatting.

20. A method comprising:
acquiring, via a packet-switched network, role designation data specifying a behavioral profile and language expression parameters for a generative information processing model;
generating, based on the role designation data and a stored base configuration, a composite instruction sequence encoding the behavioral profile and the language expression parameters;
registering an automated information processing function as a participant in a communication group on the packet-switched network;
determining, based on time data and a pseudo-random value, a transmission timing for the communication group, and transmitting to the generative information processing model an instruction sequence incorporating the transmission timing determination and the role designation data to generate an output data sequence;
acquiring text data from a terminal device, combining the text data with the composite instruction sequence, transmitting the combined data to the generative information processing model, and obtaining response data reflecting the behavioral profile; and
transmitting the response data as a data packet via the packet-switched network to the terminal device.
